(19) United States
(12) Patent Application Publication
(10) Pub. No.: US 2006/0252013 A1
(43) Pub. Date: Nov. 9, 2006

(54) System and method for identifying activity levels in a kitchen workspace and recommending zones for the same

(76) Inventors: Mohit Jain, Stevensville, MI (US); Carolina M. Mata, Stevensville, MI (US); Ali M. Vassigh, Los Angeles, CA (US); James K. Bartley, Stevensville, MI (US); Gilbert J. Urban, St. Joseph, MI (US); Guy D. Minnix, Granger, IN (US)

Correspondence Address: WHIRLPOOL PATENTS COMPANY - MD 0750;Suite 102, 500 Renaissance Drive, St. Joseph, MI, 49085, US

(21) Appl. No.: 11/124,529

(22) Filed: May 6, 2005

(51) Int. Cl. G09B 25/00

(52) U.S. Cl. 434/72

(57) ABSTRACT

A system and method is provided for identifying activity levels in a kitchen workspace and recommending zones which will facilitate the design and/or redesign of the kitchen workspace. In one embodiment, the invention relates to a software package for receiving user input relative to the user's activity level in the kitchen workspace and using that user input to identify the user's activity level and associate an identified activity level profile with one or more recommended zones for the kitchen workspace.

### BACKGROUND OF THE INVENTION

1. Field of the Invention

The invention described herein relates to a system and method for identifying activity levels in a kitchen workspace and recommending zones which will facilitate the design and/or redesign of the kitchen workspace. In one embodiment, the invention relates to a software package for receiving user input relative to the user's activity level in the kitchen workspace and using that user input to identify the user's activity level and associate an identified activity level profile with one or more recommended zones for the kitchen workspace.

2. Description of the Related Art

Whether for new construction or a remodeling project, the design of a layout of a kitchen and the selection of the equipment and appliances and cabinetry that goes into the kitchen design is often a complicated and time-consuming process. Whether by the consumer themselves or by a certified kitchen designer (CKD), the person creating the kitchen design is often at a loss to completely ascertain the user's preferences and desires with respect to the layout of the kitchen and the equipment to be used within the kitchen. Typically a kitchen designer simply uses a 2-D or 3-D layout of the physical space of the user's kitchen coupled with an estimate from the user as to the budget involved (see FIG. 1). The kitchen designer often personally interviews the user to determine the user's preferences with respect to the equipment and layout of the kitchen. Often, the user can be dissatisfied or disappointed with the end layout of the kitchen and would often prefer other equipment after the installation of the kitchen equipment is complete.

In a spectrum from planning to design to execution, the user's meeting with the kitchen designer is solely focused within the design phase of this process. Once the kitchen design is complete, the equipment and cabinets are ordered and installed in the user's kitchen in the execution phase. However, the planning stage prior to the initiation of the design meeting with the kitchen designer is critical to capturing the user's vision of what their new or remodeled kitchen would look like.

Other computer software solutions for kitchen design include the computer software programs 20/20 or Planit which essentially allows a kitchen designer to use CAD-type software program to lay out the kitchen and provide a bill of materials for installing and purchasing the equipment in the user's kitchen.

### SUMMARY OF THE INVENTION

The system and method according to the invention uncovers and captures a user's biases for the purpose of profiling and inserting the user into a classification scheme to associate the user's level of activity in the kitchen workspace with a desired kitchen zone representative of the user's actual (or desired) level of activity in one or more areas.

Each level of activity within the classification scheme has various solutions associated with them. Both the classification schemes and solutions are biased on input from users as well as experts (chefs, designers, consumers, manufactures, etc. . . . ). The system and method contemplated in the kitchen classification scheme according to the invention also contemplates a continual refinement of the solutions and classification scheme incorporated within the invention to account for changes in consumer behavior, technology (such as new innovations in the kitchen market), marketplace trends, and actual purchases made by consumers to determine whether the actual decisions made consumers match the classification scheme and the solutions associated with each stage w/in the classification scheme.

The activity level profile coupled with associated kitchen zones can then be used by a kitchen designer (or by the user themselves) to more accurately select and design the kitchen workspace to reflect the user's activities therein.

In one aspect, the invention relates to a method for recommending an appropriate kitchen workspace design comprising the steps of: defining a plurality of activities performed by a user of a kitchen workspace; associating each of the plurality of activities with at least one kitchen workspace zone; assessing the user's level of each of the plurality of activities that the user performs in their kitchen workspace; and recommending one of the at least one kitchen workspace zone corresponding to the assessed level of activity.

Various embodiments of the invention are also contemplated. The step of assessing the user's level of each of the plurality of activities can comprise the step of presenting at least one statement to the user about each of the plurality of activities and obtaining a response from the user to each of the at least one statement. The plurality of activities can comprise at least one activity selected from the group consisting of: baking, cooking, entertaining, staging, children involvement, preparation, and cleanup. The at least one kitchen workspace zone can comprise a subset of equipment appropriate for the associated activity for the at least one kitchen workspace zone. The at least one kitchen workspace zone can comprise a plurality of kitchen workspace zones, and the plurality of kitchen workspace zones are associated with at least one activity. The plurality of kitchen workspace zones associated with at least one activity can be tiered into a plurality of levels, increasing according to the amount of the associated activity a user has been assessed to perform in the kitchen workspace area. The plurality of levels can comprise at least one level selected from the group consisting of: professional, advanced and basic.

The step of assessing the user's level of each of the plurality of activities can further comprise the step of assigning a level of activity based upon the user's response to the at least one statement relevant to the particular one of the plurality of activities being assessed. The step of assessing the user's level of each of the plurality of activities can further comprise the step of generating a kitchen workspace activity profile comprising: a list of activities relevant to the user; and a recommended one of the at least one kitchen workspace zone for each of the plurality of activities in the list of activities relevant to the user.

The step of associating each of the plurality of activities with at least one kitchen workspace zone can further comprise the step of tracking information representative of at least one of (1) user responses, (2) user confirmations of a kitchen profile, (3) a user selected kitchen layout; (4) a post kitchen design survey of the user, and (5) actual user purchases. The method can further comprise the step of refining the associations between the plurality of activities and the at least one kitchen workspace zone from the tracked information.

In another aspect, the invention relates to a system for recommending an appropriate kitchen workspace design comprising: a predefined plurality of activities performed by a user of a kitchen workspace; at least one kitchen workspace zone having a predefined association with at least one of the plurality of activities; an assessment device for gauging the user's level of each of the plurality of activities that the user performs in their kitchen workspace, wherein the assessment device classifies the user's level of activity into one of at least one level within each zone and can produce output corresponding to the classified level of activity; and a recommender engine capable of receiving the output from the assessment device and displaying to a user a recommended one of the at least one kitchen workspace zone corresponding to the assessed level for each of the plurality of activities.

Further embodiments are also contemplated in accordance with this invention. The assessment device can comprise a survey comprised of a plurality of statements relating to at least one of the plurality of activities. The assessment device can comprise an interface in which a user can provide responses to the plurality of statements. The plurality of activities can comprise at least one activity selected from the group consisting of: baking, cooking, entertaining, staging, children involvement, preparation, and cleanup. The at least one kitchen workspace zone can comprise a subset of equipment appropriate for the associated activity for the at least one kitchen workspace zone.

The recommender engine can associate at least one of a plurality of activities with a corresponding appropriate tiered level of one of the kitchen workspace zones associated with the at least one activity. At least one of the assessment device and the recommender engine can generate a kitchen workspace activity profile comprising: a list of activities relevant to the user; and a recommended one of the at least one kitchen workspace zone for each of the plurality of activities in the list of activities relevant to the user. A tracking device can be operably interconnected to the associated plurality of activities and at least one kitchen workspace zone and adapted to track information representative of at least one of (1) user responses, (2) user confirmations of a kitchen profile, (3) a user selected kitchen layout; (4) a post kitchen design survey of the user, and (5) actual user purchases. The information recorded by the tracking device can be fed back into the associated plurality of activities and at least one kitchen workspace zone to refine the associations between the plurality of activities and the at least one kitchen workspace zone from the tracked information.

### BRIEF DESCRIPTION OF THE DRAWINGS

In the drawings:

FIG. 1 is a schematic drawing of a prior art kitchen design system comprising a physical layout of the kitchen workspace combined with an estimate of the users budget.

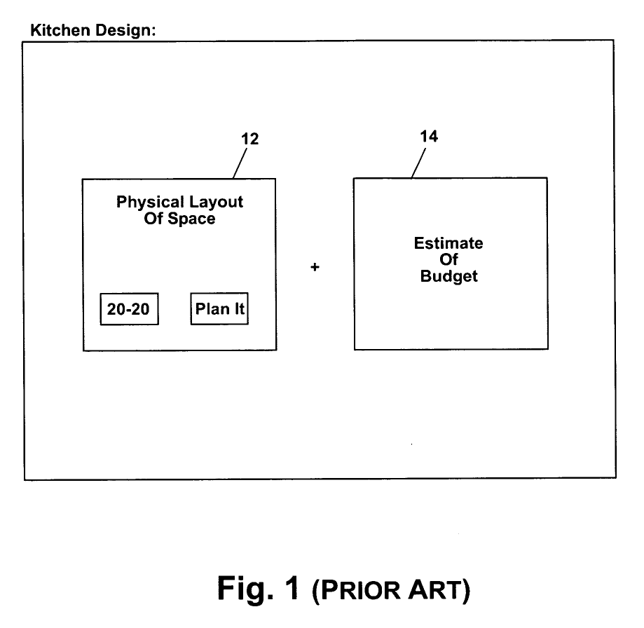

FIG. 2 is a schematic drawing of a kitchen design system according to the invention comprising a physical layout of the kitchen workspace, an estimate of the users budget, and a user-specific profile of the users activity level in the kitchen workspace.

FIG. 3 is a schematic illustration of a matrix of activities typically performed in a kitchen workspace and a corresponding matrix of representative kitchen zones, wherein each row of the matrix of representative kitchen zones corresponds to a row in the matrix of activities typically performed in the kitchen workspace.

FIG. 4 is a schematic illustration of the matrix of activities typically performed and kitchen workspace and the matrix of representative kitchen zones shown in FIG. 3 wherein the two matrices are associated with one another and by a classification scheme in order to associate a particular activity level with a respective kitchen zone.

FIG. 5 is an illustrative software interface incorporating the matrix of representative kitchen zones set forth in FIGS. 3-4.

FIG. 6 is a flow chart of the system and method of associating user activity in a kitchen workspace with representative kitchen zones appropriate for that level of activity as set forth in FIGS. 2-4.

FIG. 7 sets forth a diagram of an example kitchen zone (e.g., a “professional baking zone”) provided to a user of the illustrative software interface of FIG. 5.

FIG. 8 sets forth a diagram of an example kitchen zone (e.g., a “advanced baking zone”) provided to a user of the illustrative software interface of FIG. 5.

FIG. 9 sets forth a diagram of an example kitchen zone (e.g., a “basic baking zone”) provided to a user of the illustrative software interface of FIG. 5.

FIG. 10 sets forth a diagram of an example kitchen zone (e.g., a “professional cooking zone”) provided to a user of the illustrative software interface of FIG. 5.

FIG. 11 sets forth a diagram of an example kitchen zone (e.g., a “advanced cooking zone”) provided to a user of the illustrative software interface of FIG. 5.

FIG. 12 sets forth a diagram of an example kitchen zone (e.g., a “basic cooking zone”) provided to a user of the illustrative software interface of FIG. 5.

FIG. 13 sets forth a diagram of an example kitchen zone (e.g., a “professional cleanup zone”) provided to a user of the illustrative software interface of FIG. 5.

FIG. 14 sets forth a diagram of an example kitchen zone (e.g., a “advance cleanup zone”) provided to a user of the illustrative software interface of FIG. 5.

FIG. 15 sets forth a diagram of an example kitchen zone (e.g., a “basic cleanup zone”) provided to a user of the illustrative software interface of FIG. 5.

FIG. 16 sets forth a diagram of an example kitchen zone (e.g., a “professional entertaining zone”) provided to a user of the illustrative software interface of FIG. 5.

FIG. 17 sets forth a diagram of an example kitchen zone (e.g., a “basic entertaining zone”) provided to a user of the illustrative software interface of FIG. 5.

FIG. 18 sets forth a diagram of an example kitchen zone (e.g., a “kid's zone”) provided to a user of the illustrative software interface of FIG. 5.

FIG. 19 sets forth a diagram of an example kitchen zone (e.g., a “professional prep zone”) provided to a user of the illustrative software interface of FIG. 5.

FIG. 20 sets forth a diagram of an example kitchen zone (e.g., a “advanced prep zone”) provided to a user of the illustrative software interface of FIG. 5.

FIG. 21 sets forth a diagram of an example kitchen zone (e.g., a “basic prep zone”) provided to a user of the illustrative software interface of FIG. 5.

FIG. 22 sets forth a diagram of an example kitchen zone (e.g., a “staging zone”) provided to a user of the illustrative software interface of FIG. 5.

FIG. 23 sets forth a title screen for the illustrative software interface of FIG. 5.

FIG. 24 sets forth an initial instruction screen for the illustrative software interface of FIG. 5.

FIG. 25 sets forth a choice to a user of the illustrative software interface of FIG. 5 to enter a user input phase to discover the users activity level in the kitchen workspace to determine an ideal kitchen arrangement or to browse the kitchen zones set forth in FIGS. 7-22.

FIG. 26 is an introductory screen provided to a user to introduce the user input phase to discover the users activity level in the kitchen workspace for the illustrative software interface of FIG. 5.

FIG. 27 is an example statement set forth to a user in the user input phase to discover the users activity level in the kitchen workspace in which the user is provided with a statement and a set of icons in which the user can strongly agree, agree or disagree with the presented statement.

FIG. 28 is a flow chart for taking the user through one or more statements relating to activity in a particular kitchen zone (e.g., a “baking” zone) which will classified the user into a particular activity level based upon the users responses to the presented statements in the flow chart.

FIG. 29 is a flow chart for taking the user through one or more statements relating to activity in a particular kitchen zone (e.g., a “cooking” zone) which will classified the user into a particular activity level based upon the users responses to the presented statements in the flow chart.

FIG. 30 is a flow chart for taking the user through one or more statements relating to activity in a particular kitchen zone (e.g., a “cleanup” zone) which will classified the user into a particular activity level based upon the users responses to the presented statements in the flow chart.

FIG. 31 is a flow chart for taking the user through one or more statements relating to activity in a particular kitchen zone (e.g., a “entertaining” and a “staging” zone) which will classified the user into a particular activity level based upon the users responses to the presented statements in the flow chart.

FIG. 32 is a flow chart for taking the user through one or more statements relating to activity in a particular kitchen zone (e.g., a “kids” zone) which will classified the user into a particular activity level based upon the users responses to the presented statements in the flow chart.

FIG. 33 is a flow chart for taking the user through one or more statements relating to activity in a particular kitchen zone (e.g., a “prep” zone) which will classified the user into a particular activity level based upon the users responses to the presented statements in the flow chart.

FIG. 34 is a summary presented to the user of the illustrative software interface of FIG. 5 informing the user of the relevant areas of activity garnered from the user in the user input phase and as determined by processing the logic contained in the flow charts of FIGS. 28-33.

FIG. 35 is an additional page of the summary of FIG. 34 providing additional information to the user regarding the outcome of the analysis of the logic contained in the flow charts of FIGS. 28-33.

FIG. 36 is a schematic which associates the a signed levels of activity with a particular zone (set forth above in FIGS. 7-22).

FIG. 37 is a conclusion screen presented to the user following completion of the level of activity of the particular user in the kitchen workspace of the illustrative software interface of FIG. 5.

### DESCRIPTION OF THE PREFERRED EMBODIMENT

The system and method according to the invention uncovers and captures a user's biases for the purpose of profiling and inserting the user into a classification scheme to associate the user's level of activity in the kitchen workspace with a desired kitchen zone representative of the user's actual (or desired) level of activity in one or more areas.

Each level of activity within the classification scheme has various solutions associated with them. Both the classification schemes and solutions are biased on input from users as well as experts (chefs, designers, consumers, manufactures, etc. . . . ). The system and method contemplated in the kitchen classification scheme according to the invention also contemplates a continual refinement of the solutions and classification scheme incorporated within the invention to account for changes in consumer behavior, technology (such as new innovations in the kitchen market), marketplace trends, and actual purchases made by consumers to determine whether the actual decisions made consumers match the classification scheme and the solutions associated with each stage w/in the classification scheme.

The features of the inventive system and method of this description will now be described in greater detail.

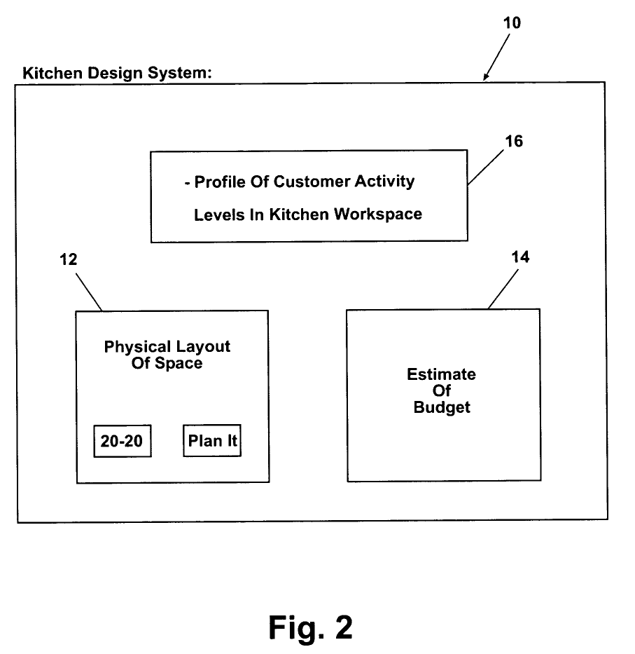

Turning to FIG. 2, a schematic drawing of a kitchen design system 10 according to the invention is set forth comprising a physical layout of the kitchen workspace 12, an estimate of the user's budget 14, and a user-specific profile 16 of the user's activity level in the kitchen workspace. The physical layout 12 and the budget estimate 14 are conventional tools long used by kitchen designers and would be apparent to one skilled in the art and need not be described further here.

It is the generation of the user-specific profile 16 which assesses and classifies the typical activity level of a user within a kitchen workspace that is the focus of the invention described herein.

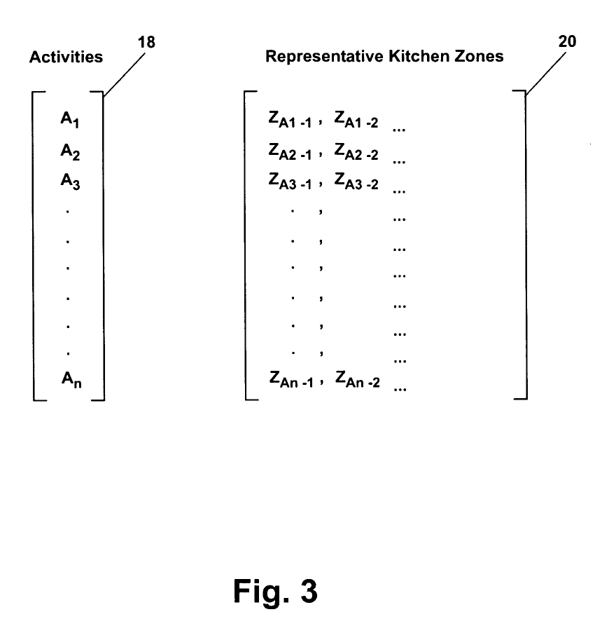

The profile 16 which is generated specific to a user's activities in the kitchen workspace begins with a predefined activity matrix 18 and a predefined kitchen workspace zone matrix 20 such as those shown by example in FIG. 3. The activity matrix 18 is illustrated by example as a single-column matrix of activities, the activities being those typically performed by a user in the kitchen workspace. The activity matrix 18 has entries shown by example as [A₁, A₂, . . . , Aₙ]. The predefined kitchen workspace zone matrix 20 is shown by example as a two-dimensional matrix having rows which correspond to each of the rows of the activity matrix 18 and, within each row is a sub-array setting forth the particular kitchen workspace zones corresponding to each activity within the activity matrix 18. For example, the representative kitchen workspace zones which correspond to the first activity [A₁] would be [Z_{A1-1}, ZA₂₋₂ . . . ]. A zone has been known for many years as being “a work triangle” where a user can perform all actions for a particular activity within a 3-5 foot triangular area.

Of course, if a particular activity [Aₓ] had only a single representative kitchen workspace zone associated with it, then the corresponding row entry within the representative kitchen workspace zone matrix 20 would simply be: [Z_{Ax-1}]. Of course, while the associations between user kitchen workspace activity and a corresponding kitchen workspace zone are shown illustratively as matrices, these associations could be stored in any suitable structure, such as a database, data file, or other storage method without departing from the scope of this invention.

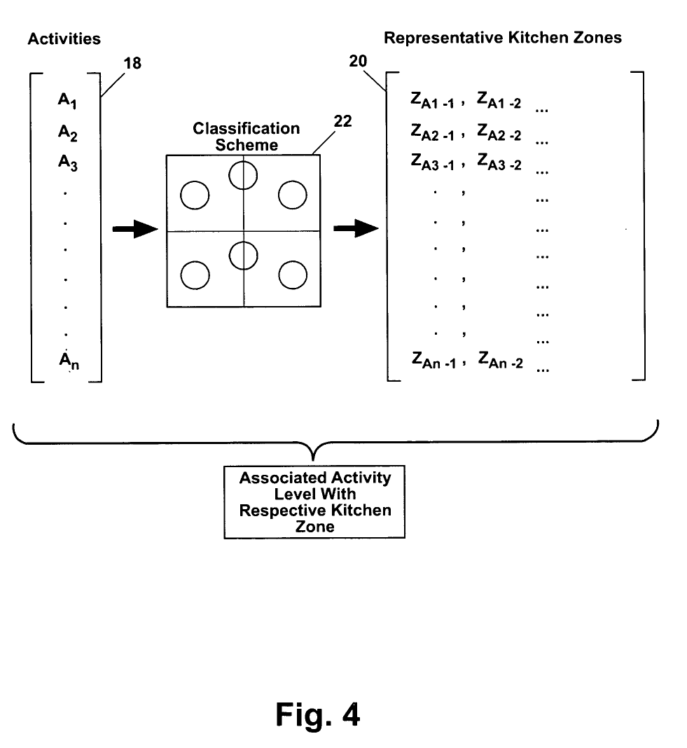

Turning to FIG. 4, a schematic illustration of the activity matrix 18 and the representative kitchen workspace zone matrix 20 shown in FIG. 3 are shown, wherein the two matrices 18, 20 are associated with one another by a classification scheme 22. The classification scheme 22 provides a map by which a particular activity level within the activity matrix 18 is associated with a kitchen zone in the representative kitchen workspace zone matrix 20. Better said, a particular activity within the activity matrix 18 can be associated with one or more kitchen zones in the representative kitchen workspace zone matrix 20 and the classification scheme 22 enables a particular kitchen zone to be looked up based upon a scalar value of a particular activity level. For example, a low level of activity can result in the classification scheme 22 recommending a basic level of kitchen zone, while a high level of activity can result in the classification scheme 22 recommending a more advanced (or even professional) level of kitchen zone.

For the purposes of this description, examples described herein will use a predefined set of activities typically performed in the kitchen workspace comprising [Baking, Cooking, Cleanup, Entertaining, Kids, Prep, Staging] (it can be thought of that the activity matrix 18 is loaded with these entries). It will be understood that additional, fewer or different user activities can be used without departing from the scope of this invention. In addition, examples of representative kitchen workspace zones will also be employed wherein each of the activities is associated with one or more kitchen workspace zones. The kitchen workspace zones described herein are tiered according to particular levels of activity. These levels are referred to herein as: professional, advanced and basic in order from the highest or most complex levels of activity down to simple or low-utility activity. It will be understood that an activity can have one, or more than one, level of kitchen workspace zone associated with that activity without departing from the scope of this invention.

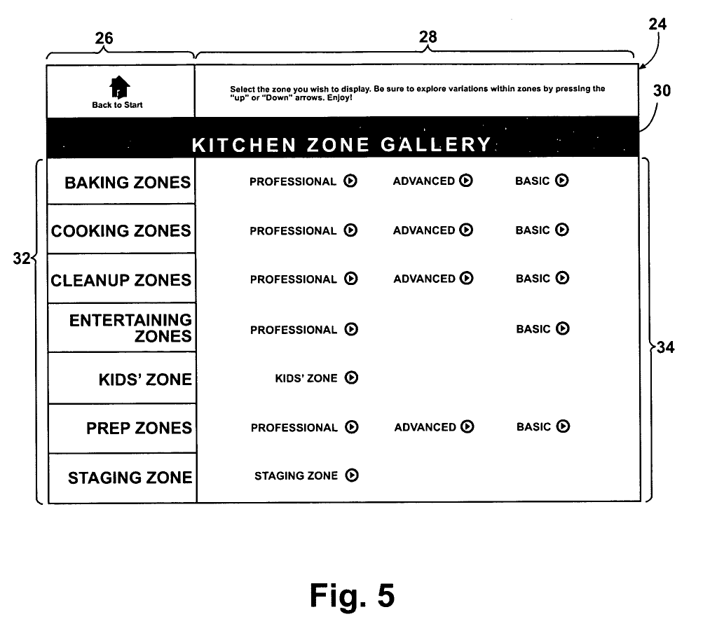

FIG. 5 is an illustrative software interface 24 incorporating the matrix of representative kitchen zones set forth in FIGS. 3-4. It will be understood that the interface is shown by example only, as there are any number of suitable interfaces which could accomplish the objectives of this invention.

The exemplary interface 24 of FIG. 5 comprises a standard computer window having a user navigation zone 26 at an upper left-hand corner thereof, an information zone 28 at an upper right-hand corner thereof, a title bar 30 extending across the window beneath the respective user navigation and information zones 26 and 28, a callout region 32 forming a column adjacent the left-hand side of the window, and a main region 34 forming the bulk of the user interface 24. In the example interface shown in FIG. 5, the predefined activity matrix 18 is shown in the callout region 32 and the representative kitchen workspace zone matrix 20, having rows associated with each activity within the activity matrix 18 is shown within the main region 34. In the event only a single zone is associated with a particular activity, there are no level indicators (e.g., “professional”, “advanced” or “basic”) associated with that zone, rather, the zone is simply referred to as the name of the activity followed by the word “zone” (e.g., refer to the single zone relating to kids' activities in the kitchen workspace named “kids' zone”).

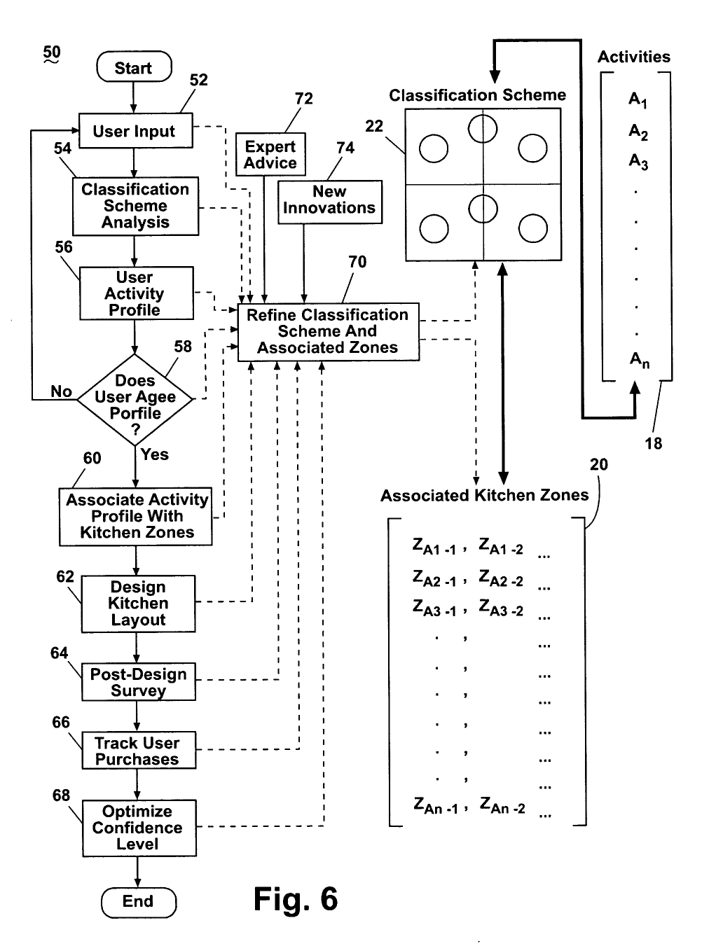

The system 10 and associated method 50 according to the invention will be further described with reference to FIG. 6. FIG. 6 is a flow chart of the system 10 and method 50 of associating user activity in a kitchen workspace with representative kitchen zones appropriate for that level of activity as set forth in FIGS. 2-4.

Turning to FIG. 6, the activity matrix 18 and kitchen zone matrix 20 are shown with the classification scheme 22 interconnecting the two to provide associations between the two. For convention purposes, the steps of the method {50} which correspond to the system 10 according to the invention are generally indicated below with bracketed numbers (e.g., {50}) for correspondence with the steps of the method {50} to the steps shown in FIG. 6.

The method {50} presumes the associated activity matrix 18 and the zone matrix 20 have been previously established when a user begins the method {50}. The user is brought to a user input phase {52} in which, for example, the user is presented with a series of statements regarding activities in the kitchen and the user assesses the personal relevance and/or importance of the statement to the user's activities in the kitchen. The user can then indicate whether the user strongly agrees, agrees or disagrees with each statement. The user's responses and then associated with the classification scheme 22 to classify each user's level of activity within each of the predetermined set of activities {54}. The method {50} then generates a user profile of activity within the kitchen workspace in which the profile generally comprises a list of one or more of the activities relevant to the user and an indicator of the scalar level of activity that the user has been classified as {56}.

The user can be given an opportunity to confirm the activity profile generated by the classification scheme 22 at {58}. If the user disagrees, processing returns to {52} and the user is given an opportunity to re-enter the user's responses to the series of statements in the user input phase. If the user agrees with the profile, processing continues to {60} in which preferably each activity provided in the activity profile generated in {56} is matched with an appropriate kitchen workspace zone corresponding to the level of activity determined within the activity profile generated in {56}.

Alternatively, the user can simply select the particular activity profile desired by the user without requiring the user to re-enter the user's responses to the series of statements already presented. For example, if the user is unhappy with rating a low level in a particular activity, the user can simply modify the rating to a higher level (e.g., “rate me as a professional entertainer, not a basic entertainer”), and vice versa. This enables the user to have an opportunity to fix any perceived mis-rated activities to the user's satisfaction.

The generated user activity profile is then provided to a kitchen designer who can then couple the user activity profile generated according to the method {50} and system 10 of this invention with the physical layout of the user's kitchen space as well as an estimate of the user's budget to determine an appropriate set of equipment and cabinetry to put in the kitchen workspace which matches the user's level of activity and preferences set forth in the user activity profile {62}.

After the kitchen has been designed at {62}, the user is then surveyed to determine whether the generated kitchen activity profile was accurate and the suggested zones were useful in laying out the actual design of the user's kitchen {64}. After the post-project survey at {64}, the user's actual actions (e.g., the actual equipment and cabinetry purchased by the user) are also tracked at {66} by an appropriate information tracking device, such as a database or other information provided by the kitchen equipment provider or other third-party source of equipment provided to the user.

It will be understood that it is also a feature of the system 10 and method {50} according to the invention that the information gathered through the steps of the method {50} are fed back into the information sources making up the activity matrix 18, zone matrix 20 and classification scheme 22 to optimize the confidence level {68} that the system 10 and method {50} described herein produce optimal results for the user and future users of the system 10 and method {50}. Examples of information that is fed back into the activity matrix 18, zone matrix 20 and classification scheme can include statistics of user responses to the user input {52}, the particular output by the classification scheme 22 {54}, records of generated user profiles {56}, whether a user typically agrees with the generated kitchen activity profile {58}, the associations between the activity profile and the particular recommended zones {60}, information representative of the actual design layout {62}, user responses to the post-design survey {64} and the actual purchase made by a user responsive to the kitchen design {66}. This feedback information is then used to refine the activity matrix 18, zone matrix 20 and classification scheme 22 {70}.

In addition, as an aside, additional external factors can also be continually provided to the classification scheme and the zone of solutions such as expert knowledge in the field (which is developed over time) {72}, new innovations in the kitchen marketplace {74} as well as market research in user patterns in the kitchen space. All can be fed into the activity matrix 18, zone matrix 20 and classification scheme 22 to improve the confidence level as well {68}. In this manner, the user becomes a design element which is coupled with the traditional elements of the physical layout of the kitchen space with an estimate of the user's budget to provide an optimal kitchen design solution.

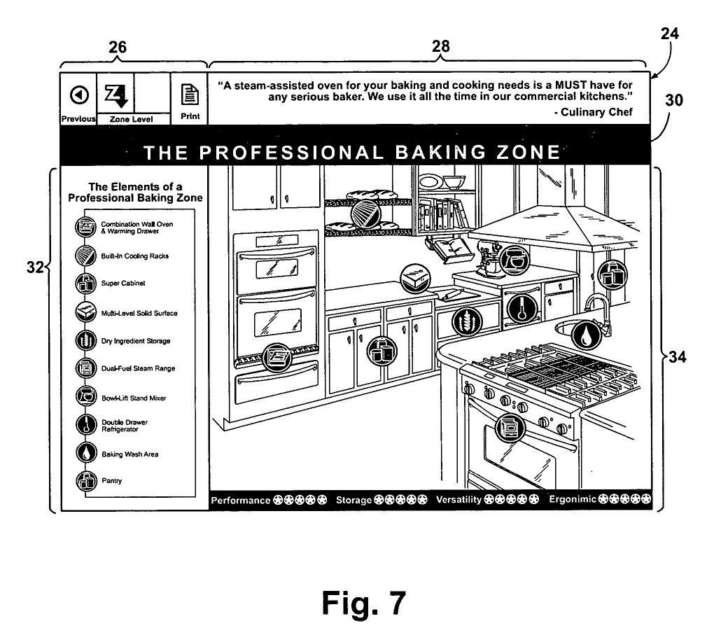

The particular predefined kitchen zones provided within the zone matrix 20 in the system 10 and method {50} will now be described with respect to FIGS. 7-22. It will be understood that the particular zones set forth in this specification are by example only and shall not be used to limit the scope of this invention. In each case, several icons are shown within the particular kitchen zone which correspond to particular kitchen-related elements (appliances, features, equipment, accessories, etc.) that can be recommended to a user who has an activity profile recommending that particular zone. In the exemplary interface 24 shown herein, moving a human interface element (such as a mouse) over the icon (whether displayed within the callout region 32 or the main region 34 results in a “pop-up” being displayed which provides more information on that particular element. Listed below the description of each zone of FIGS. 7-22 is a table which provides the description provided in the pop-up associated with each element of the particular zone.

FIG. 7 sets forth a diagram of an example kitchen zone (e.g., a “professional baking zone”) provided to a user of the illustrative software interface of FIG. 5. Elements and a description of each element are set forth below in Table 1.

TABLE 1
Professional baking zone.

| | |
|---|---|
| Combination | The KitchenAid ® Combination Oven, model KEHC309J, provides |
| Wall Oven | extra capacity for special occasions. The microwave assists with prep |
| | activities like melting chocolate for baking. |
| Warming | Keep plates or foods warm until serving with this high-performance |
| Drawer | KitchenAid ® Warming Drawer, model KEWD105H, the ideal |
| | addition to a traditional oven. |
| Built-In Cooling | Ideal for cooling large batches of cookies or several loaves of bread. |
| Racks | Reduces clutter on the counter to give you more work space. |
| Super Cabinet | Wire pull-outs. Full extension roll trays. Door Storage. |
| Multi-Level | A lower, counter-height marble slab eases the strenuous task of |
| Solid Surface | rolling dough. |
| Dry Ingredient | Typical of a commercial bakery setting, the pull-out cabinet with |
| Storage | storage bins (accessory) ensures ample supply of baking fl our, sugar |
| | and other dry ingredients. |
| Dual-Fuel Steam | KitchenAid ® Dual-Fuel Range with Steam, model KDRP767RSS, is |
| Range | a combination of steam and convection technology. Chefs have been |
| | using this technology for years. An industry first, a must-have! |
| Bowl-Lift Stand | The most powerful KitchenAid ® Stand Mixer, model KP26M1X, |
| Mixer | helps you produce professional results. |
| Double Drawer | KitchenAid ® Double Drawer Refrigerator, model KDDA27TR, |
| Refrigerator | provides you with ample refrigeration space for your baking needs |
| | where you need it most. These drawers can also be used |
| | independently. |
| Baking Wash | An additional Sink, KitchenAid ® model KSW80R0MMR and model |
| Area | KKFV01LP (faucet), in your baking zone ensures water close at hand |
| | and accommodates more than one baker in your kitchen. |
| Pantry | This tall pantry with a smooth pull-out allows you to access areas you |
| | never dreamed of reaching before. |

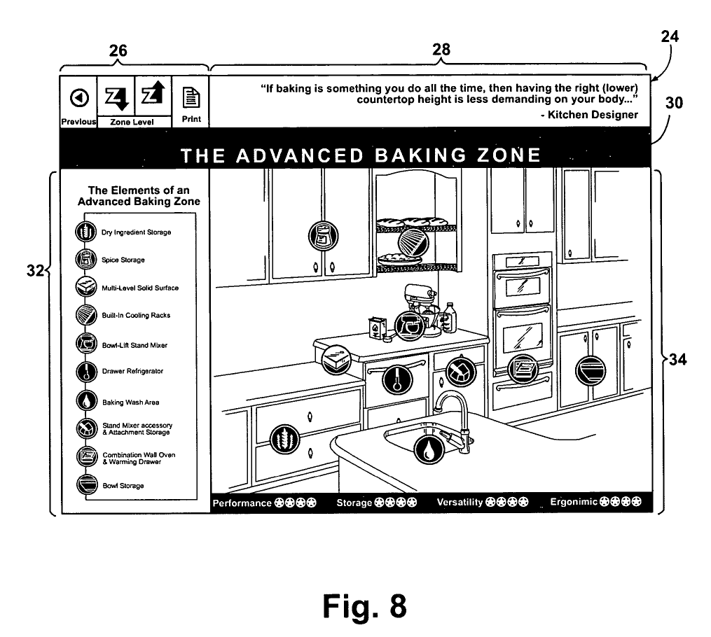

FIG. 8 sets forth a diagram of an example kitchen zone (e.g., an “advanced baking zone”) provided to a user of the illustrative software interface of FIG. 5. Elements and a description of each element are set forth below in Table 2.

TABLE 2
Advanced baking zone.

| | |
|---|---|
| Dry Ingredient Storage | Commercial style pullout cabinet with storage bins (accessory) |
| | ensures ample supply of baking fl our, sugar and other dry |
| | ingredients whether you are baking for two or twelve. |
| Spice Storage | Eye-level storage keeps spices away from heat sources. |
| Multi-Level Solid | A lower height marble slab counter will make rolling dough less |
| Surface | strenuous. |
| Built-In Cooling | Ideal for cooling large batches of cookies or loaves of breads. |
| Racks | The racks reduce clutter on the counter, and give more work |
| | space. |
| Bowl-Lift Stand Mixer | Mix large batches of heavy batter and dough with this |
| | KitchenAid ® Professional 5 Plus Series Stand Mixer, model |
| | KV25G0X. |
| Drawer Refrigerator | A KitchenAid ® Drawer Refrigerator, model KSDA24TR, |
| | supplements a primary refrigerator, providing storage in much- |
| | needed areas. |
| Baking Wash Area | An additional sink, KitchenAid ® model KSU90S0MLL and |
| | model KKFV01LP (faucet), ensures ample water in your baking |
| | zone. Also works well for more than one baker in your kitchen. |
| Stand Mixer | Accessorize cabinets with customized storage for KitchenAid ® |
| Accessory and | Stand Mixer attachments. This space-saving feature provides |
| Attachment Storage | fast storage and easy access for later use. |
| Combination Wall | KitchenAid ® Combination Oven, model KEMC308J, gives |
| Oven | extra capacity for special occasions. The microwave assists with |
| | prep activities such as melting chocolate for baked goods. |
| Warming Drawer | High-performance KitchenAid ® Warming Drawer, model |
| | KEWD105H, is ideal with a traditional oven. Keeps plates or |
| | foods warm until serving. |
| Bowl Storage | Cabinet space for mixing bowls helps the baker to reduce clutter |
| | on the counter, and have more workspace. |

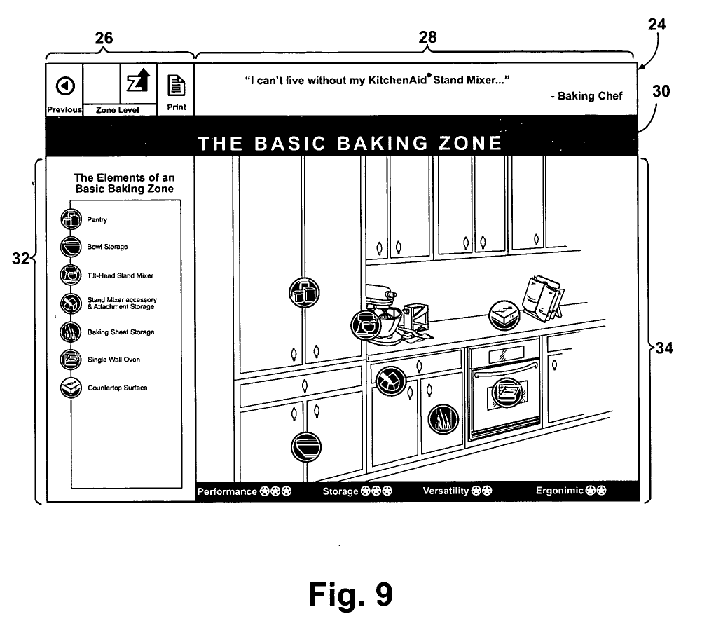

FIG. 9 sets forth a diagram of an example kitchen zone (e.g., a “basic baking zone”) provided to a user of the illustrative software interface of FIG. 5. Elements and a description of each element are set forth below in Table 3.

TABLE 3
Basic baking zone.

| | |
|---|---|
| Pantry | A tall pantry in minimal space. Smooth pullout allows you to |
| | access previously unreached areas. |
| Bowl Storage | A cabinet space for mixing bowls allows easy access to bowls |
| | when baking. Storage reduces clutter on the counter, and gives |
| | you more workspace. |
| Tilt-Head Stand Mixer | KitchenAid ® Accolade ™ Series Stand Mixers, model |
| | KN15E1X, feature tilt-head design for easy access to large 5- |
| | quart bowl. |
| Stand Mixer | Accessorize cabinets with customized storage for KitchenAid ® |
| Accessory and | Stand Mixer attachments. This space-saving feature provides |
| Attachment Storage | fast storage and easy access for later use. |
| Baking Sheet Storage | Keeps your trays, cookie sheets and cutting boards in vertical |
| | storage units. |
| Single Wall Oven | KitchenAid ® Single Built-in Oven, model KEBC107M, |
| | combines sleek design with EasyConvect ™ conversion system. |
| | Delivers professional, consistent results every time. |
| Countertop Surface | CORIAN ® surfaces look like marble and stone, and are easy to |
| | maintain. |

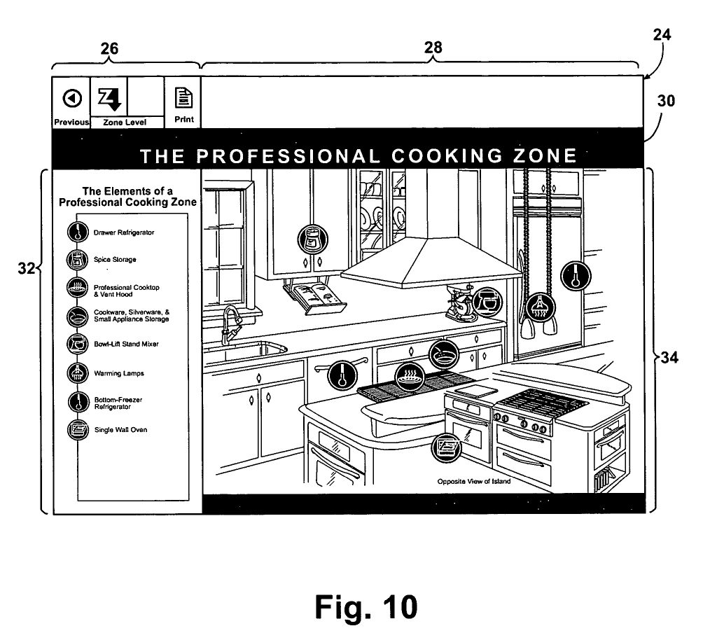

FIG. 10 sets forth a diagram of an example kitchen zone (e.g., a “professional cooking zone”) provided to a user of the illustrative software interface of FIG. 5. Elements and a description of each element are set forth below in Table 4.

TABLE 4
Professional Cooking Zone.

| | |
|---|---|
| Drawer Refrigerator | KitchenAid ® Drawer Refrigerator, model KSDA24TR, provides |
| | the refrigeration space for your fresh ingredients where you need |
| | it most. |
| Spice Storage | Spices stored at eye level away from heat sources. |
| Professional | KitchenAid ® Classic Commercial-Style Cooktop, model |
| Cooktop and Vent | KGCP462K, with a powerful Hood, model KICU265H, is what |
| Hood | every cook desires. The high-powered burners are ideal for wok- |
| | cooking. Gas burners provide you the control you desire. |
| Cookware, | Adjustable wood shelves, plenty of pullouts, generous door |
| Silverware, and | storage and the flexibility to configure it any way you want. This |
| Small Appliance | cabinet will fit equipment and cookware storage needs of every |
| Storage | chef. |
| Bowl-Lift Stand | The most powerful KitchenAid ® Stand Mixer, model KP26M1X, |
| Mixer | helps you produce professional results. |
| Warming Lamps | Used extensively in restaurants, heat lamps keep any food item |
| | warm. |
| Bottom-Freezer | KitchenAid ® Built-In Refrigerator, KBRC36FM, positions the |
| Refrigerator | refrigerated space at just the right height. Bottom drawer |
| | accommodates freezing needs |
| Single Wall Oven | The 36-inch Built-In Oven from KitchenAid, model KEBC167M, |
| | accommodates the largest cookie sheets; convection technology |
| | makes perfect results possible. |
| Warming Drawer | Warming Drawers Keep plates or foods warm with a high- |
| | performance KitchenAid ® model KEWD105H, the ideal addition |
| | to a traditional oven. |
| Built-In Microwave | This KitchenAid ® Microwave Oven, model KBMS1454S, helps |
| Oven | create a flexible cooking/prep center where you entertain. |

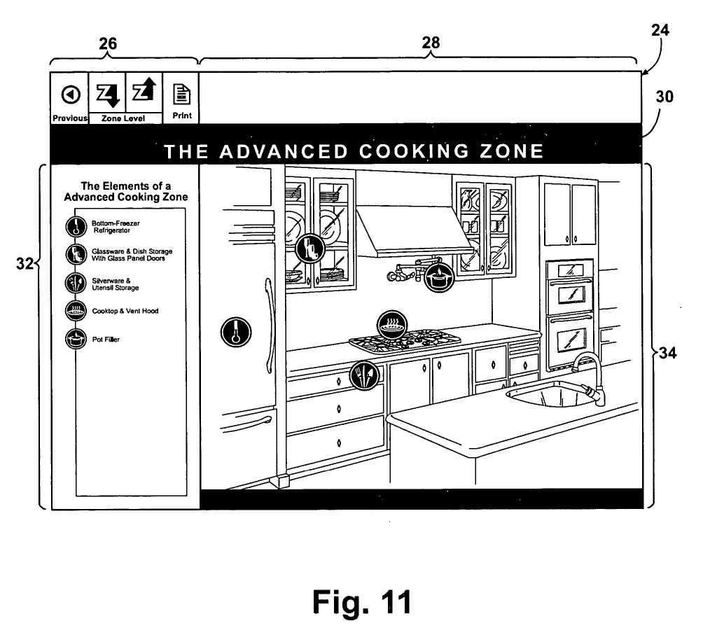

FIG. 11 sets forth a diagram of an example kitchen zone (e.g., an “advanced cooking zone”) provided to a user of the illustrative software interface of FIG. 5. Elements and a description of each element are set forth below in Table 5.

TABLE 5
Advanced Cooking Zone.

| | |
|---|---|
| Bottom-Freezer | The KitchenAid ® Built-in Refrigerator, model KBRC36FM, gives |
| Refrigerator | you the refrigerated space at just the right height. Bottom drawer |
| | serves your freezer needs. |
| Glassware and Dish | Clearly display dishware and glassware for quick access |
| Storage with Glass | |
| Panel Doors | |
| Silverware and | Drawer cabinets with storage accessories accommodate the most |
| Utensil Storage | bulky gadget to the smallest utensil. |
| Cooktop and Vent | KitchenAid ® Cooktops, like gas model KKGCC766, or electric |
| Hood | model KECC568, offer premium performance and precision. Sleek |
| | Hood design, model KWCU360J, inspires culinary |
| | experimentation. |
| Pot Filler | Eliminates the need to move heavy pots from the sink to the stove. |
| | It is a must-have item for the serious home cook. |
| Cookware Storage | Dual-action pullouts store pots, pans, and lids within easy reach. |
| Small Appliance | Organize cooking tools or ingredients in this Super Cabinet. Full |
| Storage | extension rollout trays makes storing and accessing small |
| | appliances easy. Door storage is perfect for an immersion blender |
| | or similar tools. |
| Built-In Cutting | Lose the knife block and cutting board. A cutlery cabinet liberates |
| Boards | counter space and the built-in cutting board completes the cooking |
| | zone. |
| Combination Wall | This premium KitchenAid ® Built-in Double Oven, model |
| Oven | KEBC278K, combines the sleek design with our EasyConvect ™ |
| | conversion system. Simply enter the conventional cooking time |
| | and temperature, and the oven makes the precise conversion for |
| | professional, consistent results every time. |

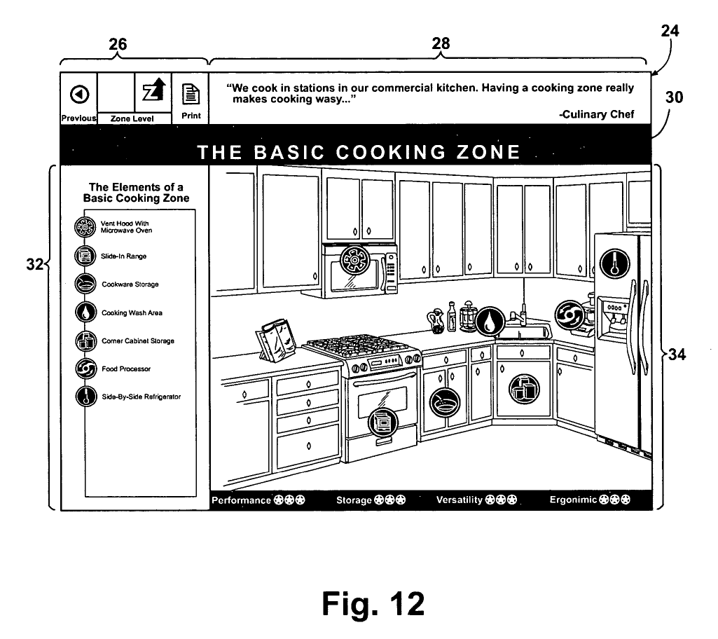

FIG. 12 sets forth a diagram of an example kitchen zone (e.g., a “basic cooking zone”) provided to a user of the illustrative software interface of FIG. 5. Elements and a description of each element are set forth below in Table 6.

TABLE 6
Basic Cooking Zone.

| | |
|---|---|
| Vent Hood with | KitchenAid ® Ultima Cook Speed Oven, model KHHS179L, |
| Microwave Oven | provides both microwave cooking and ventilation in a contemporary |
| | style. The Ultima Cook ™ feature will cook, brown or crisp foods in |
| | less time! |
| Slide-In Range | KitchenAid ® Slide-in Gas Range, model KGSA906P, combines |
| | traditional cooking with convection baking. This range features front |
| | controls and continuous cooking surface in both 30″ or 36″ sizes. |
| Cookware | Dual-action pullouts keep pots, pan lids, and cookware stored within |
| Storage | easy reach. |
| Cooking Wash | A sink in your cooking zone ensures ready supply of water when its |
| Area | needed. KitchenAid ® Sink, model KSV90L1M, and pull-out Faucet, |
| | KKFV01PP, easily fill the tallest pots. |
| Corner Cabinet | Make the most of your kitchen space by installing a corner sink |
| Storage | cabinet with storage accessories. |
| Food Processor | Powerful KitchenAid ® Food Processor, model KFP750, features a |
| | large capacity work bowl. Two big feed tubes accommodate a variety |
| | of food items. |
| Side-By-Side | KitchenAid ® Side-by-Side model KSRP25FN, provides ample |
| Refrigerator | space for frozen and refrigerated foods. A water-dispensing feature |
| | provides chilled water without opening the refrigerator door. |

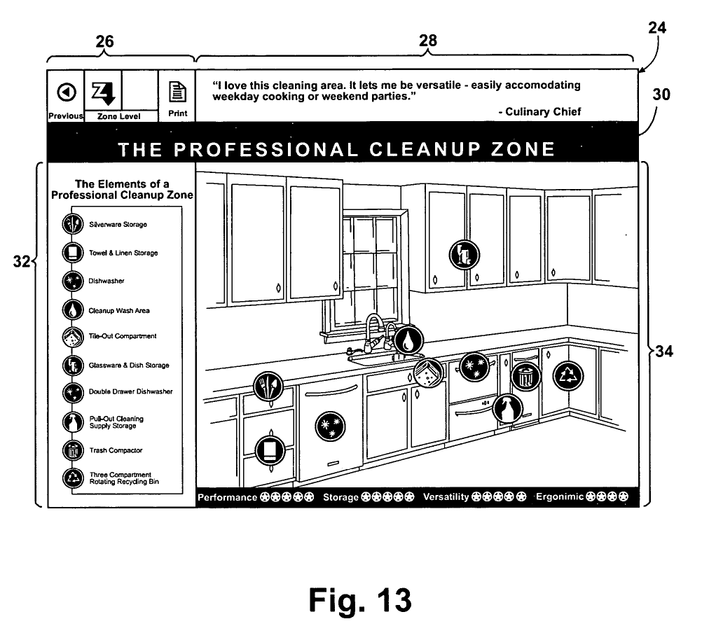

FIG. 13 sets forth a diagram of an example kitchen zone (e.g., a “professional cleanup zone”) provided to a user of the illustrative software interface of FIG. 5. Elements and a description of each element are set forth below in Table 7.

TABLE 7
Professional cleanup zone.

| | |
|---|---|
| Silverware Storage | Drawer with cutlery dividers will hold all silverware, enhancing |
| | the appearance of your cleaning area. |
| Towel and Linen | Store your towels and elegant linens in separate drawers. The |
| Storage | drawers keep your linens fresh, and tidy up your kitchen. |
| Dishwasher | Enjoy the stainless steel styling of the KitchenAid ® Architect ® |
| | Series Dishwasher, model KUDS01FL. This top-of-the-line model |
| | features a sleek, fully integrated panel that conceals all controls. |
| Cleanup Wash Area | The deep, large single bowl KitchenAid ® Sink, model |
| | KSW90L0MMR with pull-down Faucet, model KKFV01SPSS, |
| | Hard Food Disposer, model KCDS250X, and Hot Water |
| | Dispenser, model KHWG160P, allow you to easily wash large and |
| | small pots. |
| Tilt-Out | A clever option to keep sponges, scrubbers and soaps out of sight. |
| Compartment | |
| Glassware and Dish | Clean and stack your glassware and dishes upon removing them |
| Storage | from the KitchenAid ® dishwasher. |
| Double Drawer | Two independent drawers let you wash different loads on different |
| Dishwasher | cycles at the same time. KitchenAid ® Double Drawer Dishwasher, |
| | model KUDD01DPPA. |
| Pull-Out Cleaning | Makes excellent use of unusual or narrow areas. Perfect for storing |
| Supply | Storage dish soaps and other cleanup items. |
| Trash Compactor | Eliminate unsightly trash cans. KitchenAid ® Trash Compactor, |
| | model KUCC151L, offers a convenient, stylish way to handle |
| | waste. |
| Three Compartment | Rotating three-basket design expands your kitchen's capacity for |
| Rotating Recycling | handling trash and recycling. |
| Bin | |

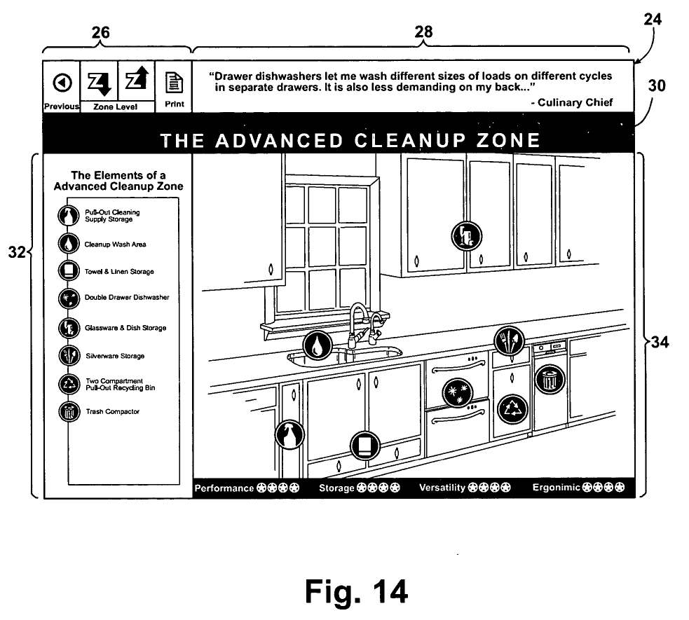

FIG. 14 sets forth a diagram of an example kitchen zone (e.g., an “advanced cleanup zone”) provided to a user of the illustrative software interface of FIG. 5. Elements and a description of each element are set forth below in Table 8.

TABLE 8
Advanced cleanup zone.

| | |
|---|---|
| Pull-Out Cleaning | Make excellent use of unusual or narrow areas. Perfect for storing |
| Supply Storage | dish soaps and other cleanup items. |
| Cleanup Wash | A 10-inch deep, Dual Bowl Sink, KitchenAid ® model |
| Area | KSW10C0MMR, combined with long, tubular Faucet, model |
| | KKFV01LPSS, Hard Food Disposer, model KCDS250X, and Hot |
| | Water Dispenser, model KHWG160PSS, allows you to wash your |
| | deepest pots without splashing water everywhere. |
| Towel and Linen | Under-the-sink storage includes space-saving linen drawers. |
| Storage | |
| Double Drawer | KitchenAid ® model KUDD01DPPA features independent drawers |
| Dishwasher | that wash small loads while saving energy. Waist-level top drawer |
| | provides easy access with less bending. |
| Glassware and | Clean and stack —that is essentially what dedicated storage for |
| Dish Storage | glassware and dishes allows you to do when it's located near your |
| | KitchenAid ® dishwasher. |
| Silverware Storage | Drawer with cutlery dividers accommodate all your silverware, |
| | eliminating clutter and chaos from your cleaning area. |
| Two Compartment | Neatly collect items for recycling without cluttering the kitchen. |
| Pull-Out | |
| Recycling Bin | |
| Trash Compactor | Do away with unsightly trash cans. KitchenAid ® Trash Compactor, |
| | model KUCC151J, offers a convenient and stylish solution for |
| | waste. |

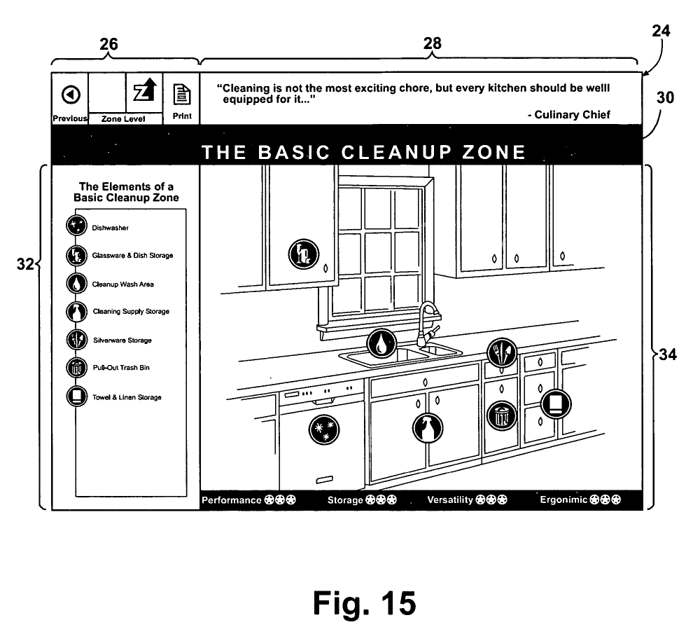

FIG. 15 sets forth a diagram of an example kitchen zone (e.g., a “basic cleanup zone”) provided to a user of the illustrative software interface of FIG. 5. Elements and a description of each element are set forth below in Table 9.

TABLE 9
Basic cleanup zone.

| | |
|---|---|
| Dishwasher | Energy Star-rated KitchenAid ® Dishwasher, model KUDI01IL, |
| | combines great cleaning performance with styling. It's built-in hard |
| | food disposer enables you to wash dishes without pre-rinsing them. |
| Glassware and | Clean and stack your glassware and dishes upon removing them from |
| Dish Storage | the KitchenAid ® dishwasher. |
| Cleanup Wash | KitchenAid ® double-bowl Sink, model KSW80C0MMR, and Faucet, |
| Area | model KKFV01LP, cleans and rinses at the same time. Hard Food |
| | Disposer, model KCDS250X, complements your Cleanup Zone. |
| Cleaning | Keep cleaning supplies handy and organized under the sink. |
| Supply Storage | |
| Silverware | Drawer with cutlery dividers accommodates all silverware, providing |
| Storage | organization to your cleaning area. |
| Pull-Out Trash | A neat way to collect items for recycling, and remove them from view. |
| Bin | |
| Towel and | Store your towels and elegant linens in separate drawers. The drawers |
| Linen Storage | keep your linens fresh and tidy up your kitchen. |

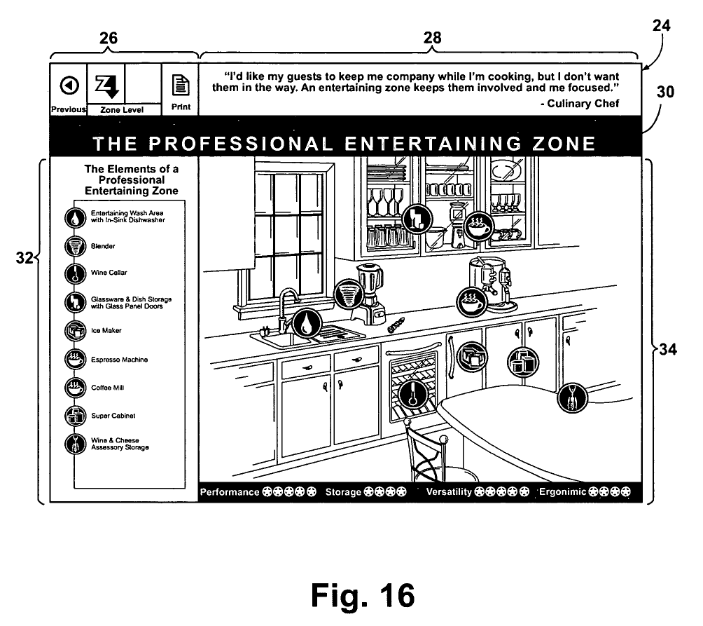

FIG. 16 sets forth a diagram of an example kitchen zone (e.g., a “professional entertaining zone”) provided to a user of the illustrative software interface of FIG. 5. Elements and a description of each element are set forth below in Table 10.

TABLE 10
Professional entertaining zone.

| | |
|---|---|
| Entertaining Wash | KitchenAid ® briva ® In-Sink Dishwasher, model KIDS36EP, |
| Area with In-Sink | provides a separate sink for entertaining and a small dishwasher |
| Dishwasher | for washing glasses in only 18 minutes. |
| Blender | Commercial-style blender has a robust design for handling tough |
| | jobs with outstanding results. This KitchenAid ® Pro Line ™ |
| | Blender, model KPES100, thoroughly blends frozen drinks and |
| | soups in just 20 seconds. |
| Wine Cellar | The perfect dinner companion, this KitchenAid ® Wine Cellar, |
| | model KUWA244P, stores up to 48 bottles of wine in three |
| | different temperature zones simultaneously! |
| Glassware and Dish | The wall cabinet with glass front, displays your fine crystal for |
| Storage with Glass | all to see and enjoy. The easy-to-access display will make your |
| Panel Doors | guests feel at home. |
| Ice Maker | A clear, crisp ice supply within easy reach for entertaining is |
| | provided by the KitchenAid ® Ice Maker, model KUIA15PRL. |
| Espresso Machine | Top off your evening with perfect cups of espresso blended in |
| | the KitchenAid ® Pro Line ™ Espresso Machine, model |
| | KPES100. |
| Coffee Mill | The KitchenAid ® A-9 Series Burr Coffee Mill, model KCM200, |
| | delivers the finest grinds of coffee and espresso. The mill |
| | combines professional performance with a legendary design. |
| Super Cabinet | Organize tools or ingredients in this Super Cabinet. Roll-out |
| | trays extend to store many items in a convenient, accessible |
| | fashion. |
| Wine and Cheese | Add a separate storage area for your wine accessories, Margarita |
| Accessory Storage | mixer, cheese cutter, etc., to make evenings more enjoyable, and |
| | to speed cleanup tasks. |

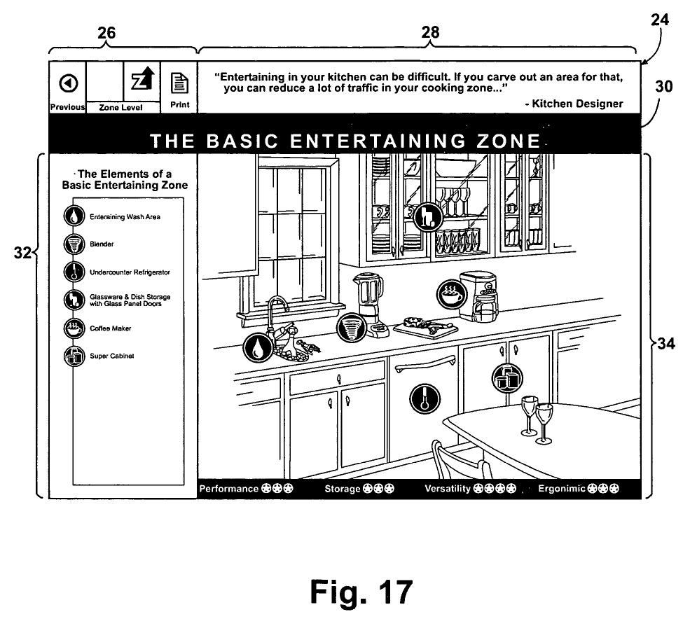

FIG. 17 sets forth a diagram of an example kitchen zone (e.g., a “basic entertaining zone”) provided to a user of the illustrative software interface of FIG. 5. Elements and a description of each element are set forth below in Table 11.

TABLE 11
Basic entertaining zone.

| | |
|---|---|
| Entertaining Wash | Entertain your guests without moving for water, |
| Area | with this KitchenAid ® Sink, model |
| | KSW55S0MMR, and Faucet, model KKFV01PP. |
| Blender | KitchenAid offers the most powerful premium |
| | blenders available. Model KSB5 features a strong |
| | motor and patented blade design.Oversized |
| | stainless steel blades crush ice at any speed. |
| Undercounter | The compact, Undercounter Refrigerator, |
| Refrigerator | KitchenAid ® model KBCA06XP, offers |
| | accessible refreshments in entertainment areas. |
| Glassware and Dish | The wall cabinet with glass front allows you |
| Storage with Glass | to display your wine and espresso glasses right |
| Panel Doors | where you need them. It is so inviting and easy to |
| | access, that even our guests will feel at home. |
| Coffee Maker | KitchenAid ® Coffee Makers evenly saturate |
| | the coffee at optimal temperatures for rich, flavorful |
| | results. |
| Super Cabinet | Organize your entertaining tools or ingredients |
| | in this Super Cabinet. Full extension rollout trays |
| | make storing and accessing things much easier. |
| | Door storage accommodates more in the same |
| | space. |

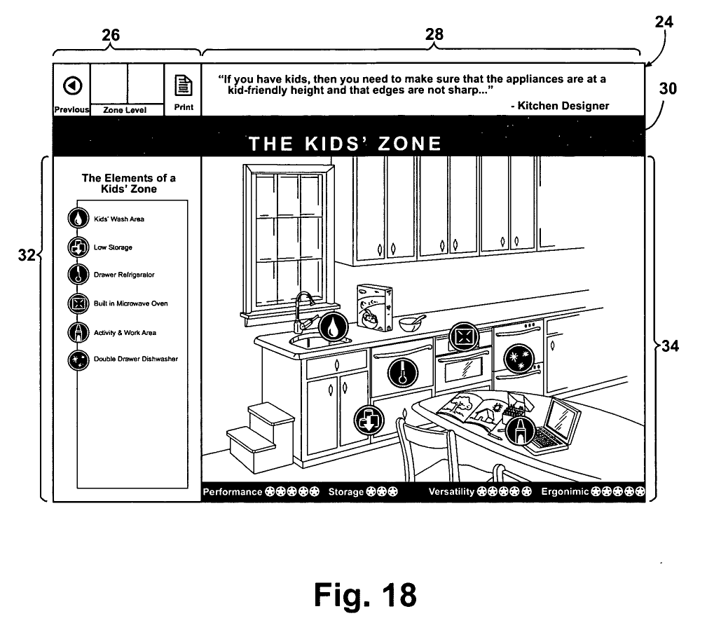

FIG. 18 sets forth a diagram of an example kitchen zone (e.g., a “kid's zone”) provided to a user of the illustrative software interface of FIG. 5. Elements and a description of each element are set forth below in Table 12.

TABLE 12
Kids' zone.

| | |
|---|---|
| Kids' Wash Area | Kids can wash their hands in their own space with this KitchenAid ® |
| | Sink, model KSW80S0MMR, and Faucet, model KKFV01LPSS. |
| Low Storage | Kids have easy access to their snacks and cereal. |
| Drawer | The KitchenAid ® model KSDA24TR Drawer Refrigerator will |
| Refrigerator | empower and encourage kids to help themselves to fresh fruits, |
| | yogurt, vegetables, and cheese. |
| Built-In | The KitchenAid ® Microwave Oven, model KBMS1454S, at kid |
| Microwave Oven | friendly height allows kids to help with the cooking or to pop |
| | themselves some popcorn. |
| Activity and | Work area for you to share with your kids when working together. |
| Work Area | |
| Double Drawer | Independent drawers in the KitchenAid ® Double Drawer |
| Dishwasher | Dishwasher, model KUDD01DPPA, accommodate kids' small loads. |

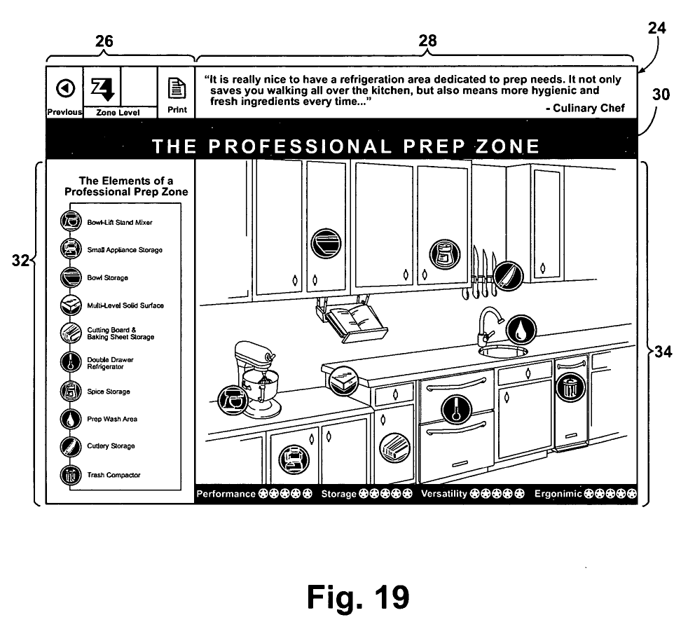

FIG. 19 sets forth a diagram of an example kitchen zone (e.g., a “professional prep zone”) provided to a user of the illustrative software interface of FIG. 5. Elements and a description of each element are set forth below in Table 13.

TABLE 13
Professional prep zone.

| | |
|---|---|
| Bowl-Lift Stand | The most powerful KitchenAid ® Stand Mixer, model KP26M1X, |
| Mixer | helps you produce professional results. |
| Small Appliance | Roll out access to tools like the KitchenAid ® Ultra Wide Mouth ™ |
| Storage | Food Processor, model KFPM770. |
| Bowl Storage | Bowls and other essential containers stored within reach. |
| Multi-Level Solid | Solid surface counters set at two heights for multitasking or to |
| Surface | accommodate multiple cooks. |
| Cutting Board and | Trays, cookie sheets, and cutting boards all stand vertically, at your |
| Baking Sheet | fingertips. |
| Storage | |
| Double Drawer | KitchenAid ® Double Drawer Refrigerator, model KDDA27TR, |
| Refrigerator | provides refrigeration space for preparation (vegetables and cheese, |
| | etc.) needs, where it's most needed. Cook in your own space while |
| | your partner prepares salad in another space. |
| Spice Storage | Spices stored at eye level away from heat sources. |
| Prep Wash Area | Complete cleaning center offers an integrated, below-the countertop |
| | Sink, model KSW80S0MMR, plus 360° swivel Faucet, model |
| | KKFV01SP, with pull down showerhead. Whisper Quiet ™ Food |
| | Waste Disposer, model KBDS250X, helps eliminate odor. |
| Cutlery Storage | Safely display your fine KitchenAid ® Cutlery within reach. |
| Trash Compactor | A fully integrated Trash Compactor, model KUCC151L, looks |
| | stylish while reducing waste storage. |

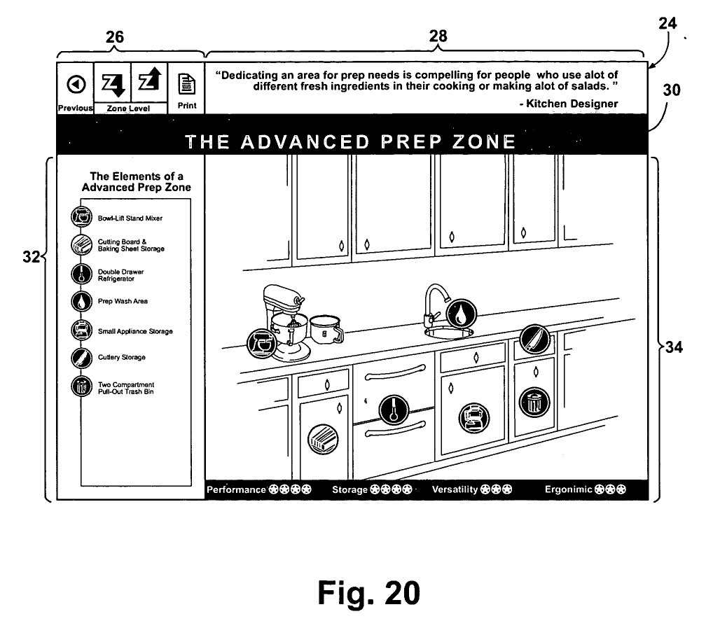

FIG. 20 sets forth a diagram of an example kitchen zone (e.g., an “advanced prep zone”) provided to a user of the illustrative software interface of FIG. 5. Elements and a description of each element are set forth below in Table 14.

TABLE 14
Advanced prep zone.

| | |
|---|---|
| Bowl-Lift Stand | Mix large batches of heavy batter and dough with this KitchenAid ® |
| Mixer | Professional 5 Plus ™ Series Stand Mixer, model KV25G0X. |
| Cutting Board and | Trays, cookie sheets, and cutting boards all stand vertically, at your |
| Baking Sheet | fingertips. |
| Storage | |
| Double Drawer | Fresh ingredients conveniently located where you need them, |
| Refrigerator | courtesy of the KitchenAid ® Double Drawer Refrigerator, model |
| | KDDA27TR. |
| Prep Wash Area | Complete cleaning center from KitchenAid, offers an integrated, |
| | below-the-countertop Sink, model KSW80S0MMR, and single |
| | lever Faucet, model KKFV01LP, with long neck. Continuous-feed |
| | Food Waste Disposer, model HCDS250X, cleans up with a flip of a |
| | switch. |
| Small Appliance | Roll out access to tools like the KitchenAid ® Continuous Chopping |
| Storage | Food Processor, model KFP750. |
| Cutlery Storage | Built-in cutlery drawer to safely store your “chef” tools. |
| Two Compartment | A neat way to separate waste items. |
| Pull-Out Trash Bin | |

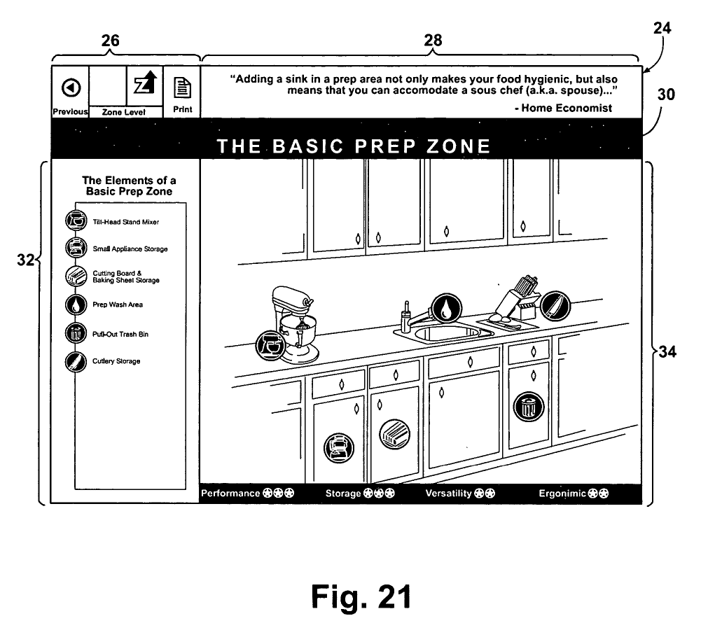

FIG. 21 sets forth a diagram of an example kitchen zone (e.g., a “basic prep zone”) provided to a user of the illustrative software interface of FIG. 5. Elements and a description of each element are set forth below in Table 15.

TABLE 15
Basic prep zone.

| | |
|---|---|
| Tilt-Head Stand | KitchenAid ® Artisan ® Series Stand Mixers, model KSM150PS, |
| Mixer | feature tilt-head design for easy access to large 5-quart bowl. |
| Small Appliance | Conveniently store small appliances like the KitchenAid ® Chef's |
| Storage | Chopper Series Food Chopper, model KFC3100. |
| Cutting Board | Trays, cookie sheets, and cutting boards all stand vertically, at your |
| and Baking Sheet | fingertips. |
| Storage | |
| Prep Wash Area | KitchenAid ® wash center includes top-mount, single bowl Sink, |
| | model KSV85E2MMR, and pull-out hose Faucet, model |
| | KKFV01PP. A continous-feed Food Waste Disposer, model |
| | KCDC250K completes the task. |
| Pull-Out Trash | Waste storage where it's needed, glides away, out of sight |
| Bin | |
| Cutlery Storage | Display your KitchenAid ® Cutlery, model KA1PB16TN, where you |
| | use it. |

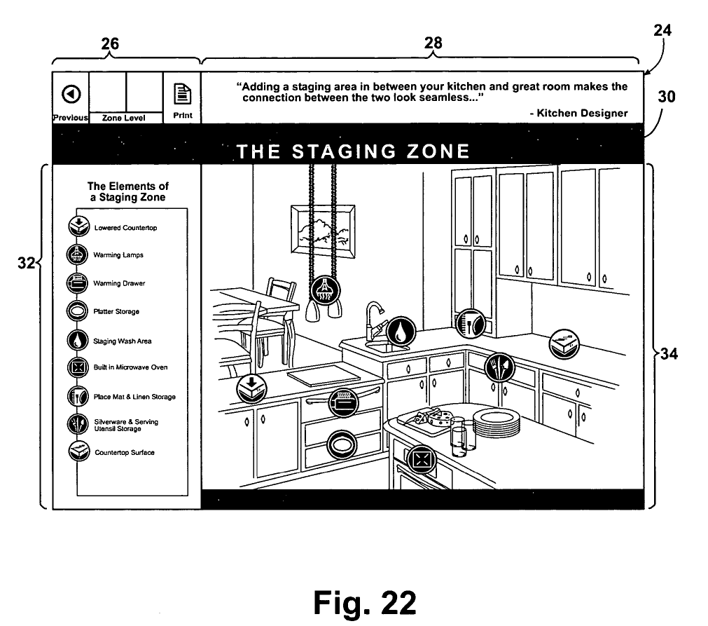

FIG. 22 sets forth a diagram of an example kitchen zone (e.g., a “staging zone”) provided to a user of the illustrative software interface of FIG. 5. Elements and a description of each element are set forth below in Table 16.

TABLE 16
Staging zone.

| | |
|---|---|
| Lowered Countertop | Lower counter heights are desirable for kids, and for other special |
| | tasks. |
| Warming Lamps | Commercial-type keep warm lamps are great when serving buffet |
| | style. |
| Warming Drawer | KitchenAid ® Warming Drawer, model KEWD105H, is a perfect |
| | addition to your staging area. Warm several dishes at the same |
| | time in this drawer. |
| Platter Storage | Your platters will stay organized and within easy reach in this |
| | drawer cabinet below your staging counter. |
| Staging Wash Area | A small Sink, KitchenAid ® model KSU90S0MLL, with self- |
| | cleaning Faucet, model KKFV01LP, provides all the water you |
| | need for entertaining. |
| Built-In Microwave | This KitchenAid ® Microwave Oven, model KBMS1454S, adds a |
| Oven | cooking/prep center to your entertainment area. |
| Place Mat and Linen | Keep place mats and linens in one central location, ready for |
| Storage | entertaining. |
| Silverware and | Drawer cabinets with storage accessories accommodate all sizes |
| Serving Utensil | of gadgets and utensils. |
| Storage | |
| Countertop Surface | CORIAN ® surfaces look like marble and stone, and are easy to |
| | maintain. |

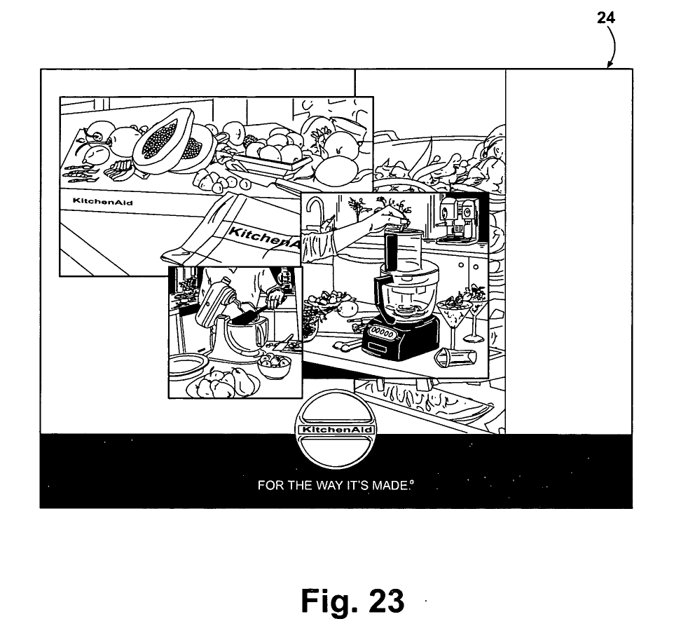

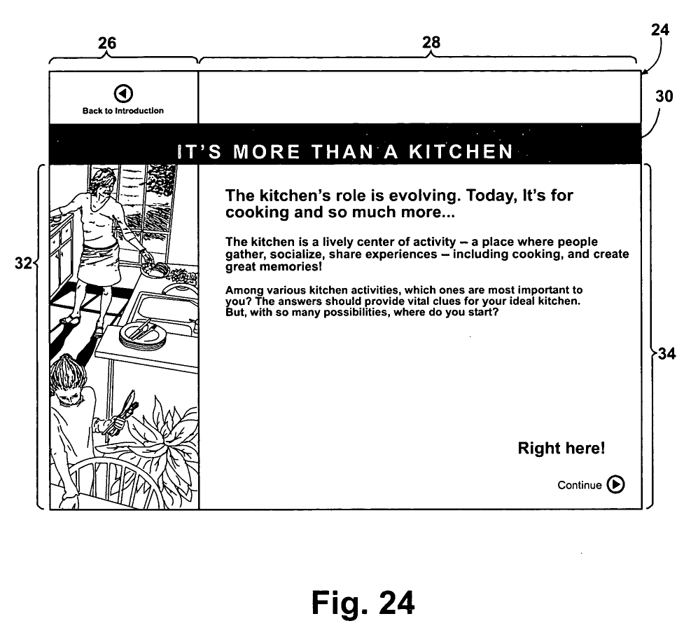

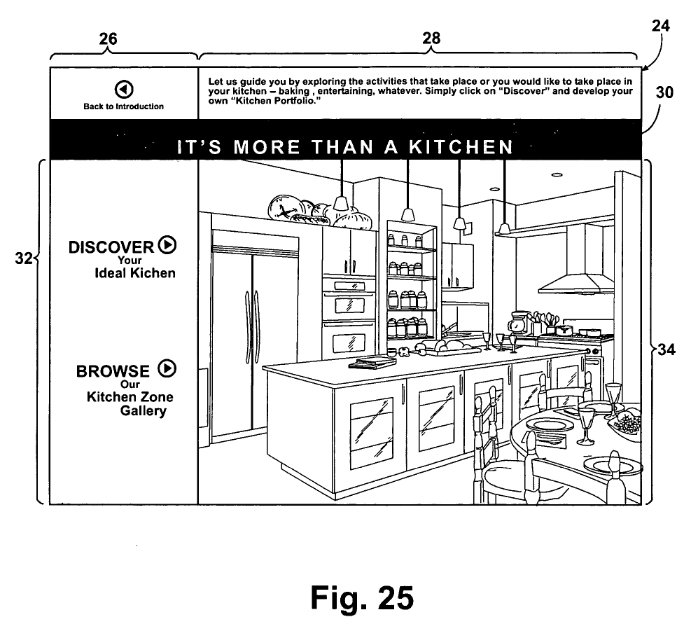

FIG. 23 sets forth a title screen for the illustrative software interface of FIG. 5. This screen can be provided when the user launches the interface 24 upon initiation of the user of the system 10 and method {50} according to the invention. Clicking on the title screen results in the initial instruction screen for the illustrative software interface 24 as shown in FIG. 24. Clicking on the screen of FIG. 24 results in the screen of FIG. 25 being displayed.

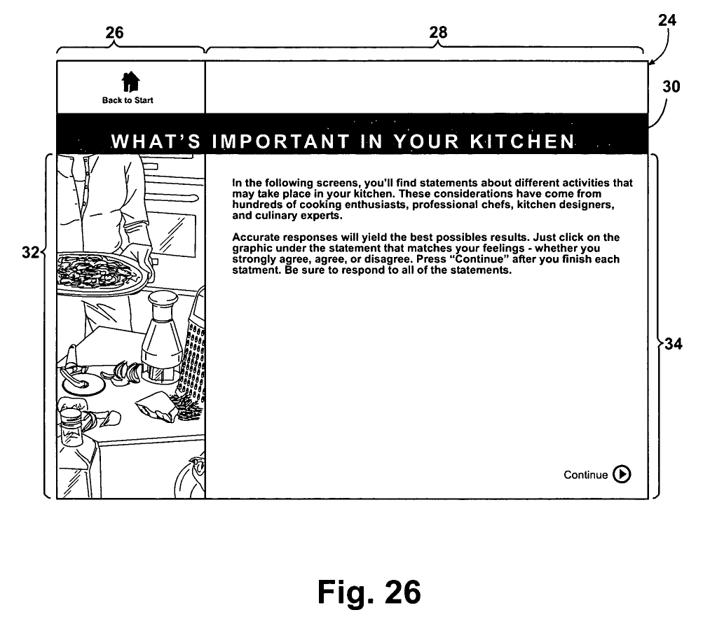

FIG. 25 sets forth a choice to a user of the illustrative software interface 24 according to the invention to enter the user input phase (see {52} in FIG. 6) to discover the user's activity level in the kitchen workspace to determine an ideal kitchen arrangement or to simply browse the kitchen zones set forth in FIGS. 7-22. If the user chooses the first option (to discover the user's kitchen activity level and to generate a kitchen activity profile), the screen of FIG. 26 is displayed. If the user chooses the second option (to browse the available kitchen zones), the user is presented with the screen of FIG. 5. The user can then click on the various names of the zones in the main region 34 associated with each activity type represented in the callout region 32 to display the particular kitchen zone described with respect to FIGS. 7-22.

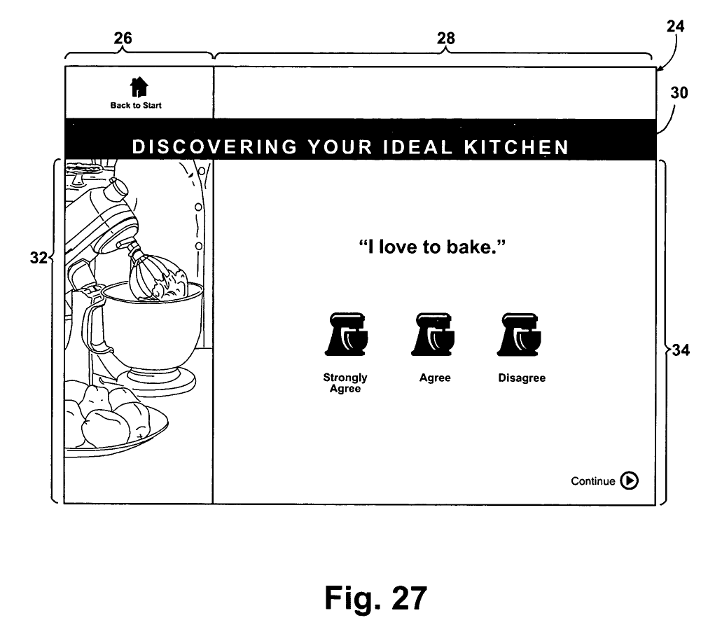

FIG. 26 is an introductory screen provided to a user to introduce the user input phase {52} to discover the user's activity level in the kitchen workspace for the illustrative software interface 24 of FIG. 5. On this screen, the user is simply provided with instructions on how to proceed with the user input phase {52} and is prompted to press the “Continue” link when the user has completed reading the instructions. Pressing the “Continue” link presents the user with a user input screen like that shown by example in FIG. 27.

FIG. 27 is an example statement set forth to a user in the user input phase to discover the user's activity level in the kitchen workspace in which the user is provided with a statement and a set of icons in which the user can strongly agree, agree or disagree with the presented statement. When presented with a screen like that shown in FIG. 27, the user would assess the statement relative to the user's activity in the kitchen as described by the statement (e.g., “I love to bake”) and click on one of the icons which most closely describes the user's personal conclusion relative to that statement, e.g., strongly agree, agree or disagree. Other scoring methods can be employed by the interface, such as numerical scoring (e.g., “Rate from 1 to 5 . . . ”), weighting of particular responses over others, and the like, without departing from the scope of this invention. Particular example statements employed in the exemplary interface 24 are set forth below with respect to each activity type, although it will be understood that the statements need not be presented to the user in any particular order.

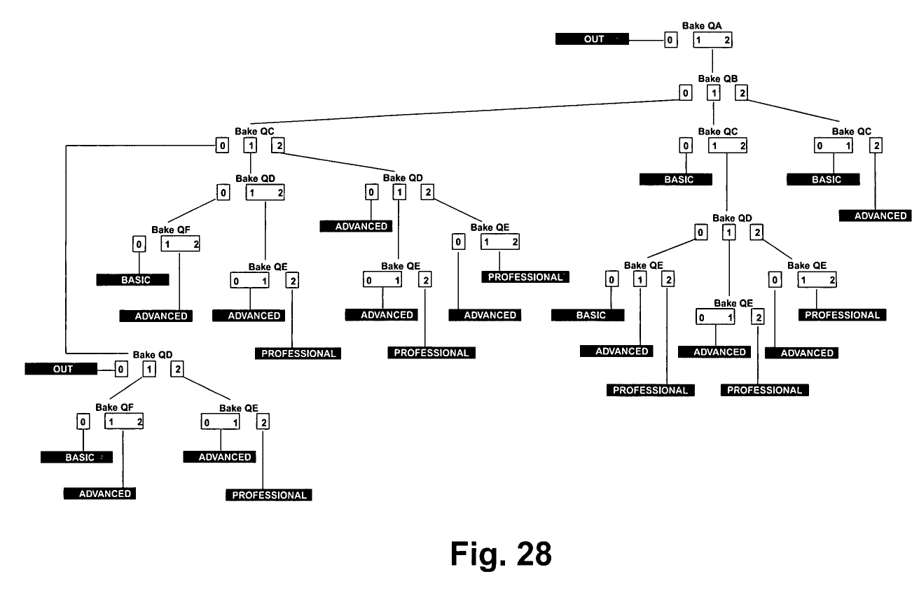

For each of the logic trees presented in FIGS. 28-33, the numbers [0], [1] and [2] represented in boxes below each statement (abbreviated in each logic tree as “QA”, “QB”, “QC”, etc. in FIGS. 28-33 and set forth in full in Tables 17-22 herein) correspond to a particular response received from the user. In the example logic set forth in FIGS. 28-33, the boxed numbers [0], [1] and [2] represent “disagree”, “agree” and “strongly agree” answers, respectively. Of course, other types, addition or fewer responses can be employed within the scope of this invention.

Flow lines extend from each of the [0], [1] and [2] boxes beneath each statement which either result in the presentation of another statement to the user or the end classification of the user into a particular activity level within that activity (e.g., professional, advanced, basic and, in some cases, none). For zones with only one defined level (e.g., the “kids” zone and the “staging” zone), the logic tree simply determines whether the zone should exist or not, rather than assigning a particular level. It will be understood that FIGS. 28-33 are an example of the classification scheme 22 which can be employed in accordance with this invention.

FIG. 28 is a flow chart for taking the user through one or more statements relating to activity in a particular kitchen zone (e.g., a “baking” zone) which will classify the user into a particular activity level based upon the users responses to the presented statements in the flow chart. Table 17 below sets forth the definition of statements “QA” through “QF” which results in the user being classified as one of a professional, advanced or basic baking activity according to the logic tree in FIG. 28.

TABLE 17
Example baking activity statements.

| | |
|---|---|
| Bake QA | I love to bake. |
| Bake QB | I only bake at holidays and special occasions. |
| Bake QC | I bake just about everything from scratch. |
| Bake QD | Homemade bread, dinner rolls, or biscuits are served |
| | with almost every meal. |
| Bake QE | Custards, souffles, pies, pastries, breads - I bake a variety |
| | of things every week. |
| Bake QF | I usually bake large batches. |

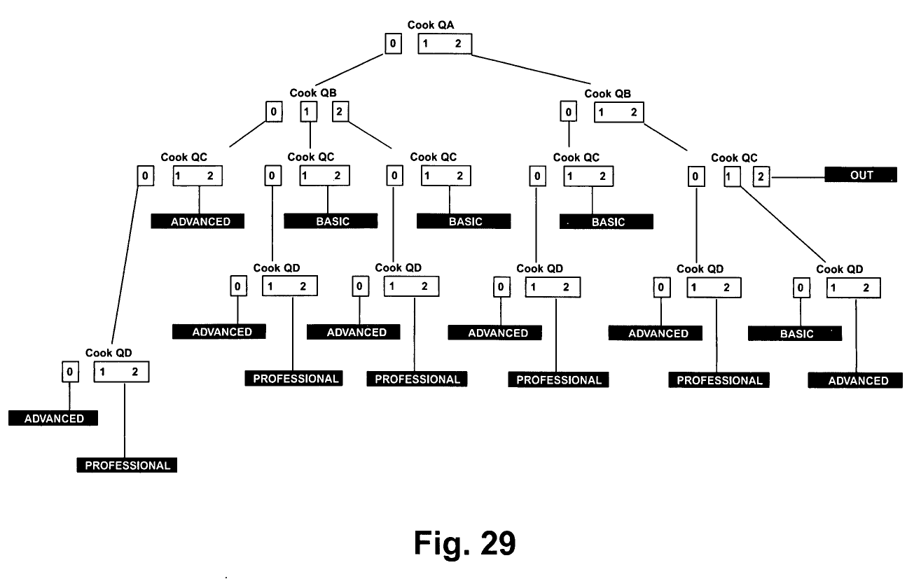

FIG. 29 is a flow chart for taking the user through one or more statements relating to activity in a particular kitchen zone (e.g., a “cooking” zone) which will classify the user into a particular activity level based upon the users responses to the presented statements in the flow chart. Table 18 below sets forth the definition of statements “QA” through “QD” which results in the user being classified as one of a professional, advanced or basic cooking activity according to the logic tree in FIG. 29.

TABLE 18
Example cooking activity statements.

| | |
|---|---|
| Cook QA | I cook less than four meals a week. |
| Cook QB | I cook for less than three people. |
| Cook QC | I prefer the meals I prepare to be quick and easy. |
| Cook QD | Cooking is my passion. |

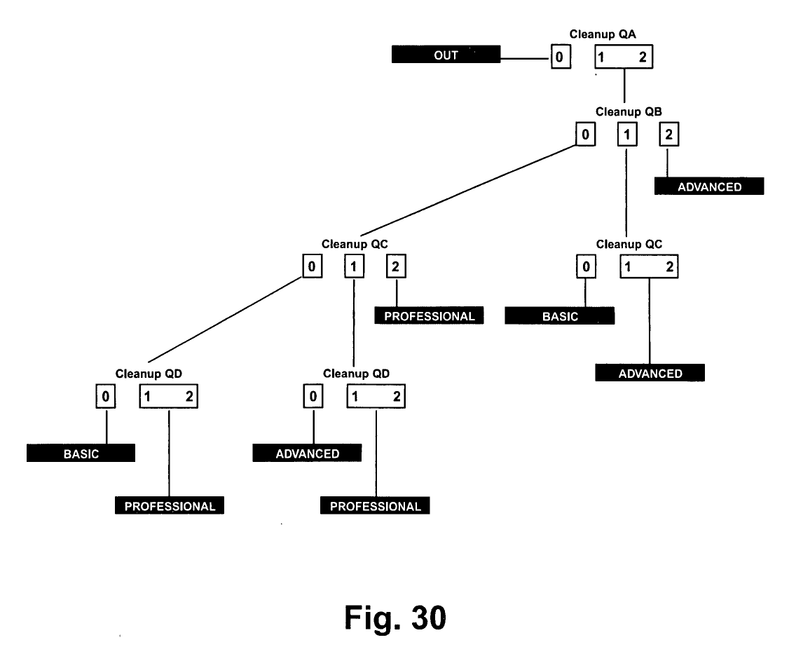

FIG. 30 is a flow chart for taking the user through one or more statements relating to activity in a particular kitchen zone (e.g., a “cleanup” zone) which will classify the user into a particular activity level based upon the users responses to the presented statements in the flow chart. Table 19 below sets forth the definition of statements “QA” through “QD” which results in the user being classified as one of a professional, advanced or basic cleanup activity according to the logic tree in FIG. 30.

TABLE 19
Example cleanup activity statements.

| | |
|---|---|
| Cleanup QA | My kitchen must be organized and spotless. |
| Cleanup QB | I don't dirty enough dishes to run a full dishwasher load |
| | every day. |
| Cleanup QC | Save the planet. I recycle everything. |
| Cleanup QD | I often prepare meals for five or more people. |

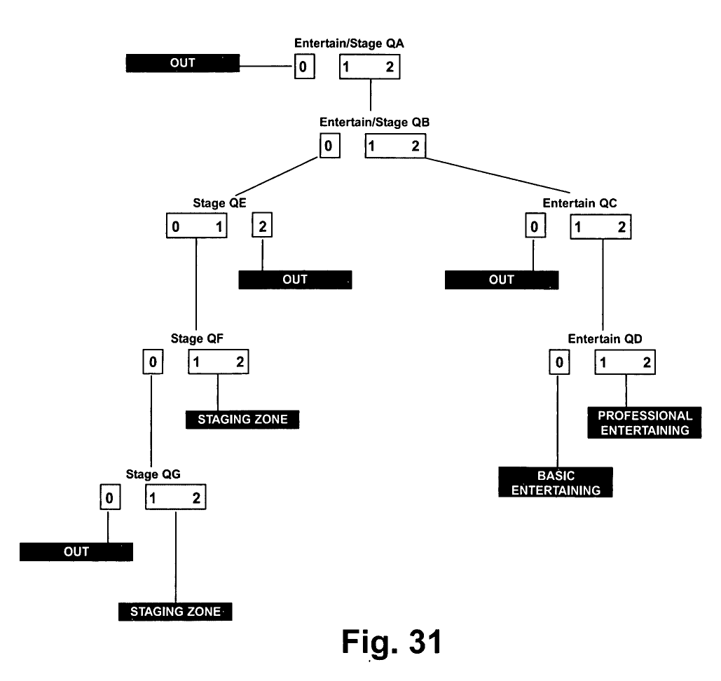

FIG. 31 is a flow chart for taking the user through one or more statements relating to activity in a particular kitchen zone (e.g., a “entertaining” and a “staging” zone) which will classify the user into a particular activity level based upon the users responses to the presented statements in the flow chart. Table 20 below sets forth the definition of statements “QA” through “QG” which results in the user being classified as either no entertainment or staging activity, professional entertaining, basic entertaining or staging activity according to the logic tree in FIG. 31.

TABLE 20
Example entertaining and staging activity statements.

| | |
|---|---|
| Entertaining/Staging QA | I like to entertain and I do it often. |
| Entertaining/Staging QB | I'm a social cook; I like to visit with my guests in the kitchen |
| | while I create my masterpieces. |
| Entertaining QC | I prefer my guests to help themselves to beverages. |
| Entertaining QD | An endless supply of ice for cocktails, fine wines chilled to |
| | perfection or steaming expresso - at my guests' fingertips - |
| | now that's entertainment. |
| Staging QE | I don't want my guests to see my kitchen when it's in use. |
| Staging QF | When I entertain, most of the food is catered or prepared |
| | before my guests arrive. |
| Staging QG | I would like to serve my guests buffet style, with easy access |
| | to my kitchen. |

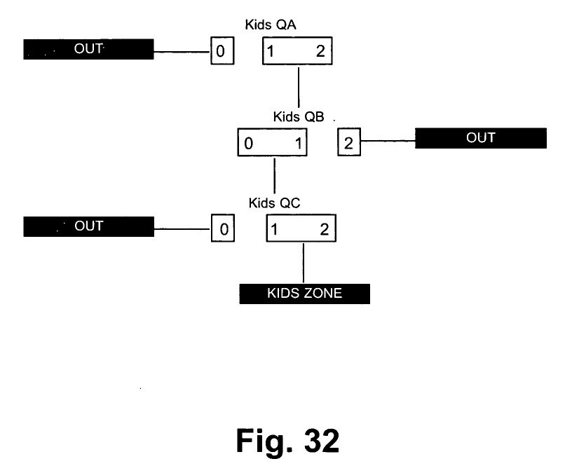

FIG. 32 is a flow chart for taking the user through one or more statements relating to activity in a particular kitchen zone (e.g., a “kids” zone) which will classify the user into a particular activity level based upon the users responses to the presented statements in the flow chart. Table 21 below sets forth the definition of statements “QA” through “QC” which results in the user being classified as either having kid-related activity in the kitchen, or none according to the logic tree in FIG. 32.

TABLE 21
Example kids activity statements.

| | |
|---|---|
| Kids QA | I have kids living in my home, they spend time with me in |
| | the kitchen. |
| Kids QB | Meal preparation in our house is a family affair, even the kids |
| | get involved. |
| Kids QC | I like the kids to be able to help themselves to snacks and |
| | the microwave while I'm cooking. |

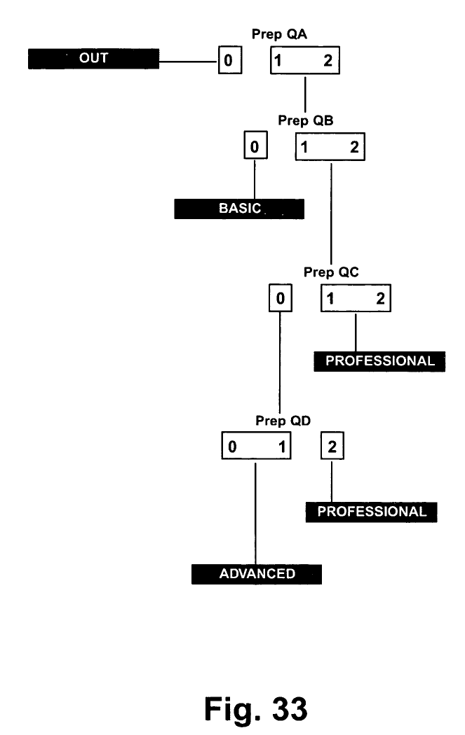

FIG. 33 is a flow chart for taking the user through one or more statements relating to activity in a particular kitchen zone (e.g., a “prep” zone) which will classify the user into a particular activity level based upon the users responses to the presented statements in the flow chart. Table 22 below sets forth the definition of statements “QA” through “QD” which results in the user being classified as one of a professional, advanced or basic prep activity according to the logic tree in FIG. 33.

TABLE 22
Example prep activity statements.

| | |
|---|---|
| Prep QA | If the ingredients aren't fresh, they don't go into my recipes. |
| Prep QB | I want quick, easy access to refrigerated ingredients in my |
| | work area. |
| Prep QC | My partner and I love cooking together as a team. |
| Prep QD | Washing, chopping, slicing, mixing, kneading, seasoning - I |
| | am the multitasking master. |

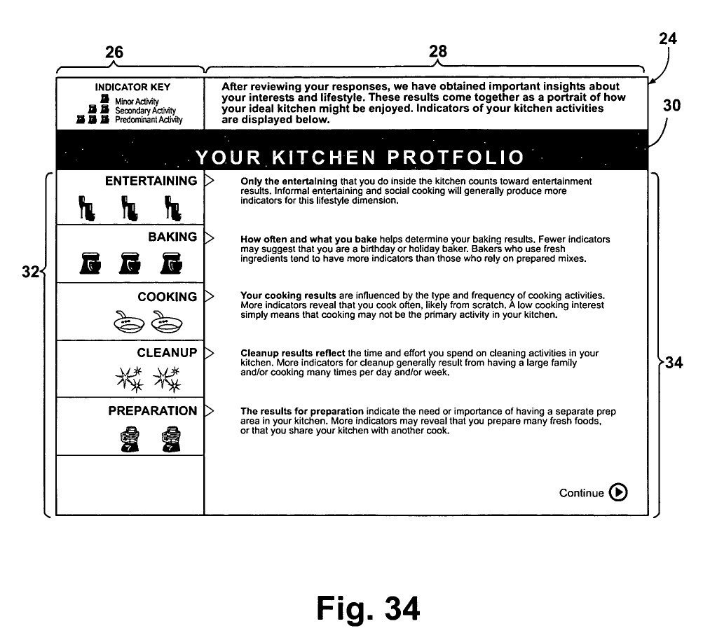

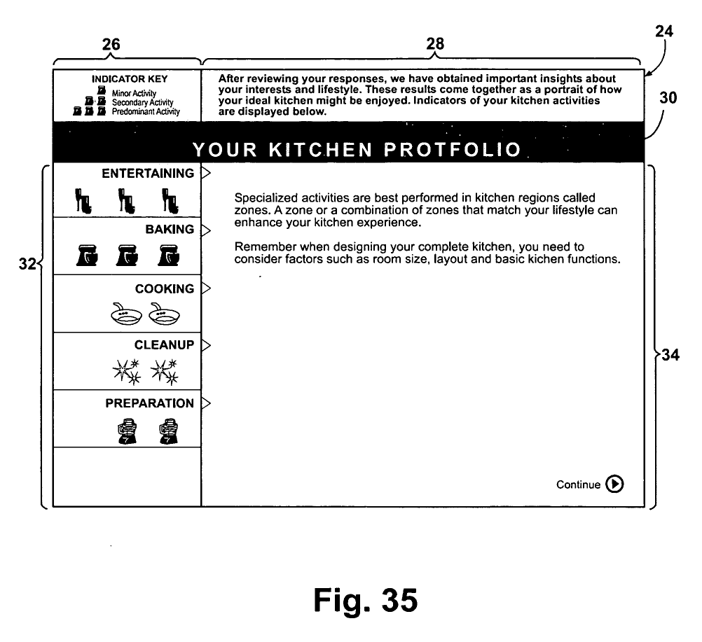

FIG. 34 is a summary presented to the user of the illustrative software interface 24 informing the user of the relevant areas of activity garnered from the user in the user input phase {52} and as determined by processing the logic contained in the flow charts of FIGS. 28-33. As can be seen in the example kitchen activity profile of FIG. 34, the callout region 32 is populated with a list of activities relevant to the user's kitchen activity profile and each listed activity has a number of icons located beneath the listed activity to indicate the level of that particular activity in the kitchen workspace. For example, the “entertaining” activity is shown as a high level (due to the three glassware icons) and the “preparation” activity is shown as a moderate level of activity (due to only two food processor icons being shown). In the example profile shown in FIG. 34, no “kids” or “staging” activities were shown because the classification scheme 22 determined they were not necessary based upon the user input {52}. Pressing the “Continue” link in the main region 34 presents the user with the screen of FIG. 35.

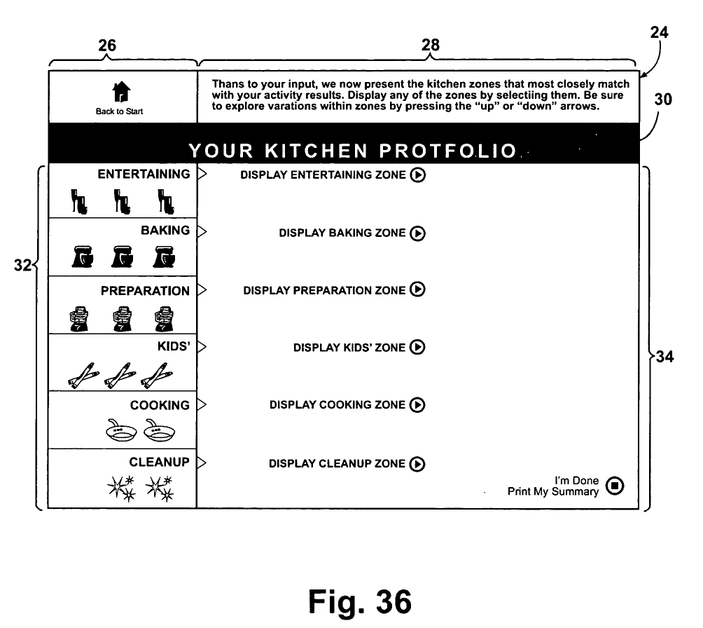

FIG. 35 is an additional page of the summary of FIG. 34 providing additional information to the user regarding the outcome of the analysis of the logic contained in the flow charts of FIGS. 28-33. Pressing the “Continue” link in the main region 34 presents the user with the screen of FIG. 36.

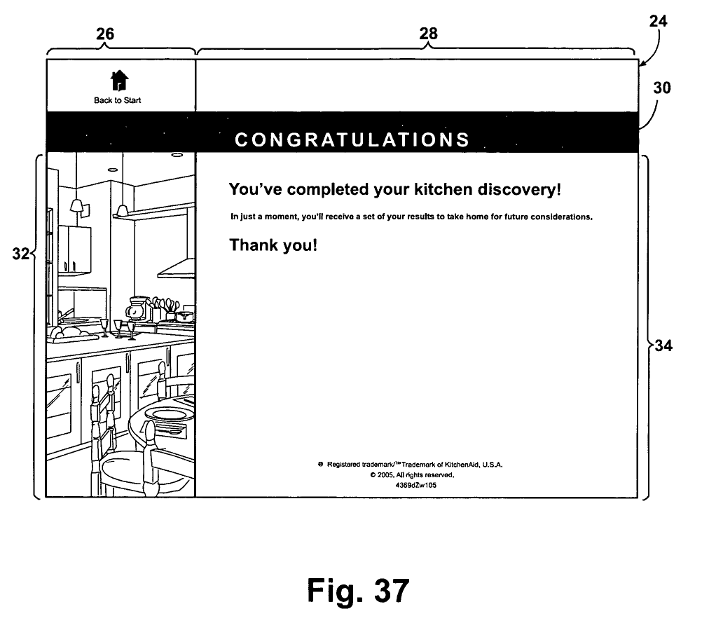

FIG. 36 is a schematic which associates the assigned levels of activity with a particular zone (set forth above in FIGS. 7-22). The screen of the interface 24 of FIG. 36 presents the user with recommended zones {60} from the zone matrix 20 associated with the particular level of activity in the generated user profile {58}. The user can click on the recommended zones for each activity type in the main region 34 of the interface 24 and be linked to the particular zone profile shown in FIGS. 7-22. Pressing the “I'm Done Print My Summary” link in the main region 34 presents the user with the screen of FIG. 37 after sending a printer-friendly document with the generated user kitchen profile and/or the recommended zones to a printer or other transmission device such as an e-mail server or a facsimile machine.

FIG. 37 is a conclusion screen presented to the user following completion of the use of the interface 24. Clicking on this screen will close the application.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method for recommending an appropriate kitchen workspace design comprising the steps of:
defining a plurality of activities performed by a user of a kitchen workspace;
associating at least one of the plurality of activities with at least one kitchen workspace zone;
assessing the user's level of each of the plurality of activities that the user performs in their kitchen workspace; and
recommending at least one kitchen workspace zone corresponding to the assessed level of activity.

2. The method of claim 1 wherein the step of assessing the user's level of each of the plurality of activities comprises the step of presenting at least one statement to the user about each of the plurality of activities and obtaining a response from the user to each of the at least one statement.

3. The method of claim 2 wherein the plurality of activities comprises at least one activity selected from the group consisting of: baking, cooking, entertaining, staging, children involvement, preparation, and cleanup.

4. The method of claim 3 wherein the at least one kitchen workspace zone comprises a subset of equipment appropriate for the associated activity for the at least one kitchen workspace zone.

5. The method of claim 4 wherein the at least one kitchen workspace zone comprises a plurality of kitchen workspace zones, and the plurality of kitchen workspace zones are associated with at least one activity.

6. The method of claim 5 wherein the plurality of kitchen workspace zones associated with at least one activity are tiered into a plurality of levels, increasing according to the amount of the associated activity a user has been assessed to perform in the kitchen workspace area.

7. The method of claim 6 wherein the plurality of levels comprise at least one level selected from the group consisting of: professional, advanced and basic.

8. The method of claim 7 wherein the step of assessing the user's level of each of the plurality of activities further comprises the step of assigning a level of activity based upon the user's response to the at least one statement relevant to the particular one of the plurality of activities being assessed.

9. The method of claim 8 wherein the step of assessing the user's level of each of the plurality of activities further comprises the step of generating a kitchen workspace activity profile comprising:
a list of activities relevant to the user; and
a recommended one of the at least one kitchen workspace zone for each of the plurality of activities in the list of activities relevant to the user.

10. The method of claim 1 wherein the plurality of activities comprises at least one activity selected from the group consisting of: baking, cooking, entertaining, staging, children involvement, preparation, and cleanup.

11. The method of claim 1 wherein the at least one kitchen workspace zone comprises a subset of equipment appropriate for the associated activity for the at least one kitchen workspace zone.

12. The method of claim 1 wherein the at least one kitchen workspace zone comprises a plurality of kitchen workspace zones, and the plurality of kitchen workspace zones are associated with at least one activity.

13. The method of claim 1 wherein the plurality of kitchen workspace zones associated with at least one activity are tiered into a plurality of levels, increasing according to the amount of the associated activity a user has been assessed to perform in the kitchen workspace area.

14. The method of claim 13 wherein the plurality of levels comprise at least one level selected from the group consisting of: professional, advanced and basic.

15. The method of claim 2 wherein the step of assessing the user's level of each of the plurality of activities further comprises the step of assigning a level of activity based upon the user's response to the at least one statement relevant to the particular one of the plurality of activities being assessed.

16. The method of claim 15 wherein the step of assessing the user's level of each of the plurality of activities further comprises the step of generating a kitchen workspace activity profile comprising:
a list of activities relevant to the user; and
a recommended one of the at least one kitchen workspace zone for each of the plurality of activities in the list of activities relevant to the user.

17. The method of claim 1 wherein the step of associating each of the plurality of activities with at least one kitchen workspace zone further comprises the step of tracking information representative of at least one of (1) user responses, (2) user confirmations of a kitchen profile, (3) a user selected kitchen layout; (4) a post kitchen design survey of the user, and (5) actual user purchases.

18. The method of claim 17 and further comprising the step of refining the associations between the plurality of activities and the at least one kitchen workspace zone from the tracked information.

19. A system for recommending an appropriate kitchen workspace design comprising:
a predefined plurality of activities performed by a user of a kitchen workspace;
at least one kitchen workspace zone having a predefined association with at least one of the plurality of activities;
an assessment device for gauging the user's level of each of the plurality of activities that the user performs in their kitchen workspace, wherein the assessment device classifies the user's level of activity into one of at least one level within each zone and can produce output corresponding to the classified level of activity; and
a recommender engine capable of receiving the output from the assessment device and displaying to a user a recommended one of the at least one kitchen workspace zone corresponding to the assessed level for each of the plurality of activities.

20. The system of claim 19 wherein the assessment device comprises a survey comprised of a plurality of statements relating to at least one of the plurality of activities.

21. The system of claim 20 wherein the assessment device comprises an interface in which a user can provide responses to the plurality of statements.

22. The system of claim 19 wherein the plurality of activities comprises at least one activity selected from the group consisting of: baking, cooking, entertaining, staging, children involvement, preparation, and cleanup.

23. The system of claim 22 wherein the at least one kitchen workspace zone comprises a subset of equipment appropriate for the associated activity for the at least one kitchen workspace zone.

24. The system of claim 19 wherein the recommender engine associates at least one of a plurality of activities with a corresponding appropriate tiered level of one of the kitchen workspace zones associated with the at least one activity.

25. The system of claim 19 wherein at least one of the assessment device and the recommender engine generates a kitchen workspace activity profile comprising:
a list of activities relevant to the user; and
a recommended one of the at least one kitchen workspace zone for each of the plurality of activities in the list of activities relevant to the user.

26. The system of claim 19 and further comprising a tracking device operably interconnected to the associated plurality of activities and at least one kitchen workspace zone and adapted to track information representative of at least one of (1) user responses, (2) user confirmations of a kitchen profile; (3) a user selected kitchen layout; (4) a post kitchen design survey of the user, and (5) actual user purchases.

27. The system of claim 26 wherein the information recorded by the tracking device is fed back into the associated plurality of activities and at least one kitchen workspace zone to refine the associations between the plurality of activities and the at least one kitchen workspace zone from the tracked information.
